(19) United States
(12) Patent Application Publication
(10) Pub. No.: US 2005/0046622 A1
(43) Pub. Date: Mar. 3, 2005

(54) Touch panel and electronic device using the same

(76) Inventors: Akira Nakanishi, Osaka (JP); Shigeyuki Fujii, Osaka (JP); Kenichi Takabatake, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/922,916

(22) Filed: Aug. 23, 2004

(30) Foreign Application Priority Data
Aug. 26, 2003 (JP) 2003-300884
Oct. 9, 2003 (JP) 2003-350497

(51) Int. Cl. G09G 5/00

(52) U.S. Cl. 345/173

(57) ABSTRACT

The invention presents a touch panel disposed at the display screen side of a liquid crystal display device or the like, and excellent in surface smoothness and environmental resistance. In marginal outer circumferential part 400B for adhering and fixing first transparent substrate 21 and second transparent substrate 31 face to face, insulating layer 27 for correction of step difference is disposed in order to make uniform the film thickness. Adhesive layer 29 is disposed on insulating layer 27, and first transparent substrate 21 and second transparent substrate 31 are adhered to each other. As a result, the adhesion fixing state if stabilized, and the adhesion strength is enhanced, and a touch panel suitable for car-mount unit excellent in surface smoothness and environmental resistance can be presented.

### FIELD OF THE INVENTION

The present invention relates to a touch panel mounted on a display screen side of a liquid crystal display device or the like capable of entering coordinate positions by pressing operation by pen or finger corresponding to the display item or display content, and an electronic device using the same.

### BACKGROUND OF THE INVENTION

Touch panels capable of entering coordinate positions by pressing operation by pen or finger corresponding to the display item or display content are widely used recently in electronic devices including portable devices.

Touch panels are available in various types. A touch panel of resistance film analog type most widely used at the present is explained below by referring to the drawings. FIG. 16 to FIG. 19 show a touch panel in a first prior art. FIG. 21 and FIG. 22 show a touch panel in a second prior art.

In the drawings shown below, for the ease of understanding of the structure of touch panel and for the sake of convenience of drawing, the dimension in the thickness direction of touch panel is magnified.

Also for the sake of explanation, terms showing relative positional relation are used such as upside, upper, upper end, downside, lateral, front end, front side, rear end, rear side, forward, outside, and outward. However, they do not express the absolute position of the touch panel or members or parts composing the touch panel. It must be understood that they merely express the relative location of members and parts disposed in a front view of the drawing for the sake of explanation.

A first prior art is explained. FIG. 16 is a top view of touch panel in the first prior art, FIG. 17 is its perspective exploded view, and FIG. 18 and FIG. 19 are sectional views along line A-A in FIG. 16.

In FIG. 16 to FIG. 19, on the top of first transparent substrate 1, first transparent conductive film 2 composed of indium tin oxide (ITO) or the like is formed on the entire surface by sputtering method or the like.

As shown in FIG. 16, further, touch panel operation region 400 is composed nearly in a rectangular shape in the central region of first transparent substrate 1. Herein, the majority of touch panel operation region 400 is a so-called visible region, and is presented for the operating region and viewing region for the user.

Further, as shown in FIG. 18, on first transparent substrate 2 in touch panel operation region 400, dot spacers 5 of small size made of insulating epoxy resin are formed at specified pitches.

First transparent substrate 1 is composed of glass plate, or sheet of polycarbonate resin or acrylic resin. It may be also made of other material, such as biaxially drawn polyethylene terephthalate film, polycarbonate film, or the like.

Light permeable second transparent substrate 3 is disposed oppositely to first transparent substrate 1. In the entire lower side of second transparent substrate 3, second transparent conductive film 4 of ITO or the like is formed by sputtering or other method. First transparent conductive film 2 and second transparent conductive film 4 are disposed face to face across a specified interval by way of touch panel operation region 400 having dot spacers 5.

First transparent conductive film 2 and second transparent conductive film 4 are both formed on the entire surface of first transparent substrate 1 and second transparent substrate 3. That is, the undesired portions of the conductive films are not removed by etching.

First transparent substrate 1 and second transparent substrate 3 are disposed face to face, being adhered with marginal outer circumferential parts 400A, 400B, 400C formed to surround touch panel operation region 400.

The upside of second transparent substrate 3 as touch panel operation side is manipulated by pen or finger, and its shape may be deformed or flawed. To prevent such flaw, hard coat layer 6 of about 3H of pencil hardness made of acrylic resin or the like is provided on the upside of second transparent substrate 3.

As shown in FIG. 16 and FIG. 17, flexible printed circuit (FPC) 7 has a connector function for connecting with external device (not shown) electrically connected to first transparent conductive film 2 and second transparent conductive film 4.

Also as shown in FIG. 16 and FIG. 17, first transparent substrate 1 forms undercoat resist layer 11 of insulating material,for example,in U shape,on marginal outer circumferential parts 400B and 400C corresponding to the outer part of touch panel operation region 400 on first transparent conductive film 2 formed on its entire surface. The shape of undercoat resist layer 11 is not limited to U shape. For example, it may be formed in L shape, or other shape.

Undercoat resist layer 11 is usually made of epoxy resin or acrylic UV resin, and formed, for example, by screen printing.

To enhance the insulation, undercoat resist layer 11 may be printed in two layers. On first transparent conductive film 2, linear electrode 12 is formed in forward part IF of undercoat resist layer 11 and rear end 1B of first transparent substrate 1.

A pair of electrodes 12 are positioned parallel to each other, and each electrode is directly connected electrically to first transparent conductive film 2.

Wiring pattern 12A linking to pair of electrodes 12 is disposed on undercoat resist layer 11. Undercoat resist layer 11 is disposed for preventing undesired electrical contact with first transparent conductive film 2 formed on the entire surface of first transparent substrate 1. End portions of wiring pattern 12A are gathered at forward position 1F side of first transparent substrate 1. That is, wiring pattern 12A is gathered at the side to be connected to FPC 7.

On undercoat resist layer 11 of first transparent substrate 1, wiring pattern 13A for second transparent conductive film 4 formed on second transparent substrate 3 is disposed. Its end portions are gathered at forward position 1F of first transparent substrate 1 same as wiring pattern 12A.

On the other hand, on second transparent conductive film 4 of second transparent substrate 3, linear electrodes 14 are formed at right and left facing en positions 4A orthogonal to electrodes 12. Electrodes 14 are also parallel to each other, and each electrode is disposed in an electrically connected state directly on second transparent conductive film 4.

The upper end of electric connection conductor 15 disposed on wiring pattern 13A is connected to each electrode 14. By way of electric connection conductor 15, each electrode 14 is electrically connected to wiring pattern 13A disposed on first transparent substrate 1.

On first transparent substrate 1, the upside of electrodes 12, wiring pattern 12A and wiring pattern 13A is covered with overcoat resist layer 16 which is one of marginal members. Further thereon, another marginal member, adhesive layer 17 is overlaid, and adhered to second transparent substrate 3. First transparent substrate 1 and second transparent substrate 3 are adhered and disposed in confronting state. Thus, by marginal members of overcoat resist layer 16 and adhesive layer 17, first transparent substrate 1 and second transparent substrate 3 are adhered by means of marginal outer circumferential parts 400A, 400B and 400C.

Operation of the conventional touch panel is described. By pressing the specified position from above second transparent substrate 3 by finger or pen, second transparent substrate 3 is partially deflected down ward mainly from the operated position. Corresponding to the operated position, first transparent conductive film 2 and second transparent conductive film 4 contact with each other partially.

At this time, even in the area of touch panel operation region 400, other parts than the operated position are defined by dot spacers 5, and are kept in contact-free state. In this state, by applying specified voltage alternately to electrodes 12 and electrodes 14 of first transparent conductive film 2 and second transparent conductive film 4, the voltage ratio at contact points is obtained through FPC 7, and on the basis of this value, the input operation position is calculated in an external circuit (not shown).

This prior art is disclosed, for example, in Japanese Laid-open Patent No. H4-284525.

A second prior art of touch panel is explained. FIG. 20 is a top view of the second prior art of touch panel, and FIG. 21 is a sectional view along line G-G in FIG. 20.

In FIG. 20 and FIG. 21, first transparent substrate 1 composed of glass plate, or sheet of polycarbonate resin or acrylic resin. First transparent substrate 1 may be also formed of biaxially drawn polyethylene terephthalate film, or polycarbonate film.

On the upside of first transparent substrate 1, first transparent conductive film 2 of ITO or the like is formed by sputtering or other method. Dot spacers 5 of small size are formed of insulating epoxy resin or the like at specified pitch on first transparent conductive film 2.

On the downside of second transparent substrate 3, second conductive film 4 made of ITO or the like is formed by sputtering or other method. Second transparent conductive film 4 is insulated from first transparent conductive film 3 by way of touch panel operation region 400, and is disposed oppositely across a specified interval. In the outward portion of touch panel operation region 400, that is, in marginal outer circumferential part 400B, first transparent substrate 1 and second transparent substrate 3 are adhered face to face by way of undercoat resist layers 130, 90 and overcoat resist layers 140, 100.

Also in marginal outer circumferential part 400A, at the side of first transparent substrate 1, wiring by printed and dried film of conductive paint having silver powder dispersed in the resin is formed at first transparent substrate 1 side, together with electrode for supplying voltage to transparent conductive film 2 (hereinafter called wiring and electrode pattern) 80, and also insulating undercoat resist layer 90, overcoat resist layer 100, and adhesive layer 110 for adhering and fixing first transparent substrate 1 and second transparent substrate 2 are formed in specified patterns.

At the side of second transparent substrate 3, similarly, marginal outer circumferential part 400B is formed in specified pattern together with wiring and electrode pattern 120, insulating undercoat resist layer 130, and overcoat resist layer 140. The structure of marginal outer circumferential part 400C is similar to that of marginal outer circumferential part 400A or marginal outer circumferential part 400B.

In FIG. 21, first transparent substrate 1 and second transparent substrate 3 are intact, not etching first transparent conductive film 2 and second transparent conductive film 4 in pattern. Accordingly, undercoat resist layers 90, 130 are formed in the lower part of wiring and electrode patterns 80, 120. However, by etching only necessary parts of first transparent conductive film 2 and second transparent conductive film 4 in pattern, when the wiring parts of wiring and electrode patterns 80, 120 and transparent conductive films are designed not to overlap, undercoat resist layers 90, 130 may not be formed.

FPC 150 is a kind of connector for connecting lead-out signals from first transparent conductive film 2 and second transparent conductive film 4 to external devices (not shown).

In FPC 150, copper foils are plated in specified pattern in base material film 160 of insulating resin, and a plurality of wiring patterns 170 are formed. Cover lay 180 is an insulator covering parts not to be exposed of wiring patterns 170. FPC 150 is thermally bonded and adhered and fixed on first transparent substrate 1 so that wiring patterns 170 may be electrically connected to wiring and electrode patterns 80 and 120 by way of anisotropic conductive film 190.

Further, protective layer 200 and protective layer 210 include thermosetting resins such as silicone resin and UV cured acrylic resin applied to the compression area of FPC 150 to first transparent substrate 1. It is formed by coating by dispenser or the like in order to reinforce adhesion of FPC 150, and prevent sulfurization and migration wiring and electrode pattern 80 of first transparent substrate 1 and wiring pattern 170 of FPC 150.

Generally, one of the demands of users about the touch panel is decrease of area of marginal outer circumferential parts 400A, 400B and 400C located outside of touch panel operation region 400. To meet this demand, usually, the distance from the compression part of FPC 150 and second transparent substrate 2 is suppressed within 1 mm, and further in order to enhance the reinforcing effect of the adhesion fixing force, the end portion of protective layer 200 disposed at the upper side of first transparent substrate 1 is formed in contact with second transparent substrate 3.

This prior art is disclosed in Japanese Laid-open Patent No. H10-91345.

However, in the touch panel of the first prior art, in order to assure the insulation, undercoat resist layer 11 must be printed and overlaid at the side of first transparent substrate 1. Accordingly, undercoat resist layer 11 is relatively thick, about 30 to 50 μm, or as much as 80 μm. If overcoat resist layer 16 and adhesive layer 17 are overlaid on undercoat resist layer 11, the height position may be uneven in the existing portion and absent portion of undercoat resist layer 11. To eliminate this inconvenience, while repeating trial and error, appropriate adhering and heating conditions of first transparent substrate 1 and second transparent substrate 3 must be found out. That is, it takes much time and labor to find appropriate processing conditions.

When setting of heating and pressing conditions is improper, as shown in FIG. 19, adhesion strength by the adhesive layer may not be sufficient in a certain width X due to effects of step difference portions. If a relatively wide adhesive layer 17 is provided for enhancing the adhesion strength, adhesion portions of first transparent substrate 1 and second transparent substrate 3 are only partial, and the adhesion strength is lowered. As a result, surface smoothness of second transparent substrate 3 is lost, and the visual recognition, controllability and quality of the touch panel are lowered.

To prevent such inconvenience, the heating and pressing conditions in gluing process of first transparent substrate 1 and second transparent substrate 3 must be set at relatively high temperature and pressure, and heating and pressing process must be done for a long time. Therefore, from the viewpoint of reduction of number of working processes, the prior art still has many problems to be solved.

Recently, the touch panel is used in navigation system and other car-mount applications. In particular, in car-mount applications, while severe environmental resistance is demanded, along with reduction of size of devices, there is an increasing demand for narrow margin touch panel of small size and wide touch panel operation region, that is, narrowed in the width size of marginal outer circumferential parts.

In the touch panel of the second prior art shown in FIG. 20 and FIG. 21, by adhesive layer 110 formed in marginal outer circumferential parts 400A, 400B, and 400C of touch panel operation region 400 for adhering and fixing first transparent substrate 1 and second transparent substrate 3, it is designed to relax the stress due to difference in coefficient of thermal expansion between the two substrates. Therefore, it was nearly satisfactory as the environmental resistance demanded in consumer product applications.

However, as the touch panel is recently used in car-mount applications, the required environmental resistance is much severer than in consumer product applications.

Accordingly, to confirm the degree of satisfaction of environmental resistance test of conventional touch panels, they were exposed in atmosphere of high temperature and high humidity, for example, temperature of 70° C. and relative humidity of 90%, or 85° C. and 85%. When the touch panels were observed after test, the surface of second transparent substrate 3 was found to be corrugated and not smooth. In the case of protective layer 200 of thermosetting type, it was found that protective layer 200 did not act sufficiently for stress relaxation due to difference in coefficient of thermal expansion between first transparent substrate 1 and second transparent substrate 3. That is, in the conventional touch panel, the surface smoothness of second transparent conductive film 3 on touch panel operation region 400 is lost, and the appearance of touch panel and quality of touch panel deteriorate, that is, there were problems in the aspects of visual recognition, controllability and quality of touch panel.

### SUMMARY OF THE INVENTION

The touch panel of the invention is intended to solve the problems of the prior arts. It is hence a primary object thereof to present a touch panel capable of adhering and fixing between substrates in the adhesion region of marginal outer circumferential parts of the touch panel, more stabilized than in the prior arts, and excellent in surface smoothness and environmental resistance of touch panel in spite of narrowed width of marginal outer circumferential parts of the touch panel, and an electronic device using the same.

It is also an object of the invention to present a touch panel capable of preventing variation of surface smoothness of second transparent substrate presented for touch panel operation in severe condition of use, that is, atmosphere of high temperature and high humidity, and not spoiling the appearance of the touch panel.

To achieve these objects, the touch panel of the invention is a touch panel comprising a first transparent substrate forming a first transparent conductive film on the upside, a second transparent substrate forming a second transparent conductive film on the downside, and marginal outer circumferential parts for adhering the transparent substrates mutually while keeping the conductive films face to face across a specified interval, in which a correction insulating layer for correcting step difference in the marginal outer circumferential parts is interposed in the marginal outer circumferential parts, an adhesive layer is formed at the position correcting the step difference by the insulating layer, and the first transparent substrate and second transparent substrate are adhered by the adhesive layer.

In this constitution, the first transparent substrate and second transparent substrate can be stably maintained in a strong adhesion state by disposing the adhesion layer in the specified portion of the wiring and electrode of touch panel having the insulation layer for correction of step difference. Further, the width of marginal outer circumferential parts can be narrowed, that is, a touch panel of narrowed marginal edges can be presented. In spite of the structure of touch panel of narrowed marginal edges, the surface smoothness is assured in severe environmental condition of use. Besides, since the adhesive layer is disposed in a uniform height position, the conductive state of heat and pressure is uniformly dispersed, and the adhesion job efficiency is enhanced.

In other touch panel of the invention, the FPC for connection with external device is connected to either one of the first transparent substrate and second transparent substrate, and the other substrate not having the FPC has a notch for releasing the outer shape of the FPC. At the notch side and its opposite side, electrodes of transparent conductive films of the substrates are disposed. After adhering the first transparent substrate and second transparent substrate, the FPC can be disposed easily, and setting of connecting condition and connecting operation of the FPC are easy.

Further, by disposing electrodes of transparent conductive films of the substrates at the notch side and its opposite side, it is possible to eliminate adverse effects on the linearity of transparent conductive films of the substrate due to the notch portion, so that the linearity characteristic of the touch panel electrodes can be easily maintained.

In the touch panel of the invention, moreover, the FPC is connected to either one of the first transparent substrate and second transparent substrate, and an electric connection conductor to be electrically connected to the electrode of the transparent conductive film of other substrate is disposed at the FPC connected side. This structure is intended to dispose the electric connection conductor at the FPC disposed side where a broader width is required in the marginal outer circumferential part, and hence an electric connection conductor of a wide shape can be disposed, and its connection state is much stabler.

In the touch panel of the invention, the FPC is enclosed between the first transparent substrate and second transparent substrate. Such structure is slightly lower in the working efficiency. But the advantage is that it can be composed easily even in the case of substrate made of glass or the like. Another merit is that it has no effect on the size of the side of disposing the electrode in the transparent conductive film. As a result, without having the effect of substrate material, the degree of freedom of design of pattern is enhanced.

Further, in the touch panel of the invention, the FPC is of double sided substrate type, and is enclosed between the first transparent substrate and second transparent substrate. In the wiring parts disposed at both sides of the FPC, moreover, wiring patterns drawn out from the electrodes of transparent conductive films of the substrate are electrically connected respectively. As a result, electric connection conductor is not required between the first transparent substrate and second transparent substrate. Still more, the wiring pattern space is saved. As a result, the width of marginal outer circumferential parts existing outside of the touch panel can be further narrowed, and the so-called touch panel of narrow marginal edge is realized, and the area of the touch panel operation region is substantially widened.

In the touch panel of the invention, a polarizer or circular polarizer is disposed on the second transparent substrate. The second transparent substrate is adhered to the marginal outer circumferential part of the touch panel with a strong adhesion with the first transparent substrate, and therefore if the polarizer or circular polarizer is warped, the degree of effect of warp can be reduced.

Other aspect of the touch panel of the invention is a touch panel comprising a first transparent substrate forming a first transparent conductive film on the upside, a second transparent substrate forming a second transparent conductive film on the downside, a connector connected to at least one of the first transparent substrate and second transparent substrate, and a protective layer applied on the connection area of the connector, in which the protective layer is not in contact with the transparent substrate not adhered to the connector out of the first transparent substrate and second transparent substrate.

In this constitution, there is no effect of protective layer on the transparent substrate not adhered to the FPC, that is, the stress due to difference in coefficient of thermal expansion between the first transparent substrate and second transparent substrate can be absorbed and lessened by the adhesive layer. Therefore, if used in severe condition of use of atmosphere of high temperature and high humidity, variation of surface smoothness of the second transparent substrate placed at the touch panel operation side can be kept to a minimum, and the touch panel excellent in visual recognition, controllability and quality can be presented.

In other touch panel of the invention, the transparent substrate not adhered to the FPC of the first transparent substrate and second transparent substrate has a notch so as not to contact with the protective layer applied around the compression area of the FPC.

In this structure, contact of protective layer of FPC and transparent substrate can be avoided, and a wide area of adhesive layer is assured in other region than the vicinity of the FPC, so that a touch panel of narrow marginal edge is realized, while excellent visual recognition, controllability and quality can be easily obtained.

In other touch panel of the invention, moreover, the distance between the connector and the transparent substance not adhered to the FPC of the first transparent substrate and second transparent substrate is set at 2 mm or more. By coating with a dispenser or the like so as not to contact with the transparent substance not adhered to the FPC of the first transparent substrate and second transparent substrate, it is easier to form the protective layer, and the manufacturing yield of touch panels is enhanced, and a higher quality can be obtained.

Also in other touch panel of the invention, the projective layer around the compression area of FPC is made of material of JIS K 7117-2, and formed of a coating agent of cold setting or thermosetting resin with viscosity of 0.7 Pa.s or more. Thus, wetting and spreading of coating agent when coating by dispenser or the like can be suppressed. It is further easier to form the protective layer without contacting with the transparent not compressed with the FPC of the first transparent substrate and second transparent substrate.

In addition, the electronic device of the invention is an electronic device having a touch panel disposed at the display screen side of a display device, and designed to execute specified functions by judging the specified signal obtained by operation on this touch panel by a control circuit. Since this touch panel is excellent in surface smoothness and environmental resistance, the appearance of the electronic device using this is not spoiled, and the reliability is enhanced in the environment of use.

### BRIEF DESCRIPTION OF THE DRAWINGS

FIG. 1 is a top view of touch panel in an exemplary embodiment of the invention,

FIG. 2 is a perspective exploded view showing FIG. 1,

FIG. 3 is a sectional view along line A-A in FIG. 1,

FIG. 4 is a top view of touch panel in other exemplary embodiment of the invention,

FIG. 5 is a perspective exploded view of touch panel shown in FIG. 4,

FIG. 6 is a sectional view along line B-B in FIG. 4,

FIG. 7 is a sectional view along line C-C in FIG. 4,

FIG. 8 is a top view of touch panel in a different exemplary embodiment of the invention,

FIG. 9 is a perspective exploded view of touch panel shown in FIG. 8,

FIG. 10 is a top view of touch panel in a fourth exemplary embodiment of the invention,

FIG. 11 is a sectional view along line D-D in FIG. 10,

FIG. 12 is a top view of touch panel in a different exemplary embodiment of the invention,

FIG. 13 is a sectional view along line E-E in FIG. 13,

FIG. 14 is a top view of touch panel in a different exemplary embodiment of the invention relating to FIG. 12, and

FIG. 15 is a perspective exploded view of car navigation liquid crystal monitor as an example of electronic device of the invention.

FIG. 16 is a top view of touch panel in a first prior art,

FIG. 17 is a perspective exploded view of touch panel of prior art shown in FIG. 16,

FIG. 18 is a sectional view along line F-F of prior art in FIG. 16,

FIG. 19 is a sectional view along line F-F of prior art in FIG. 16 for explaining a state of lack of adhesion,

FIG. 20 is a top view of touch panel in a second prior art, and

FIG. 21 is a sectional view along line F-F in FIG. 20.

### DETAILED DESCRIPTION OF THE EXEMPLARY EMBODIMENTS

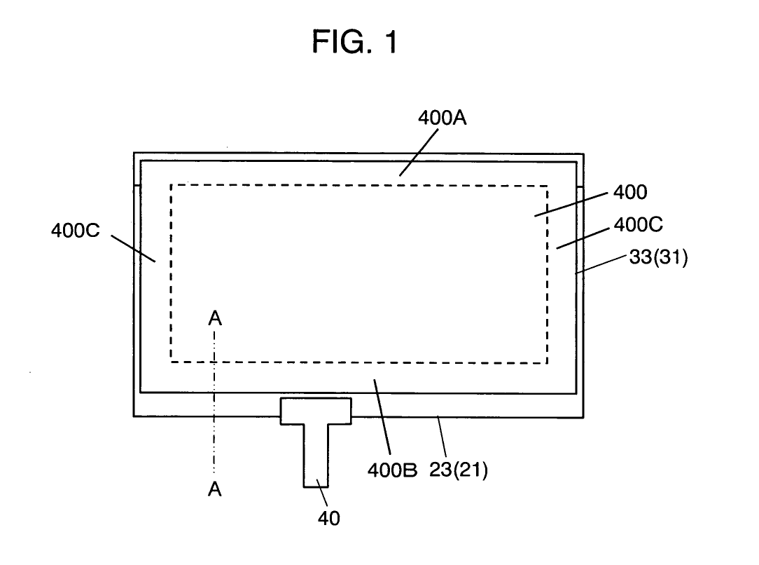

Exemplary embodiments of the invention are described specifically below while referring to FIG. 1 to FIG. 15.

### First Exemplary Embodiment

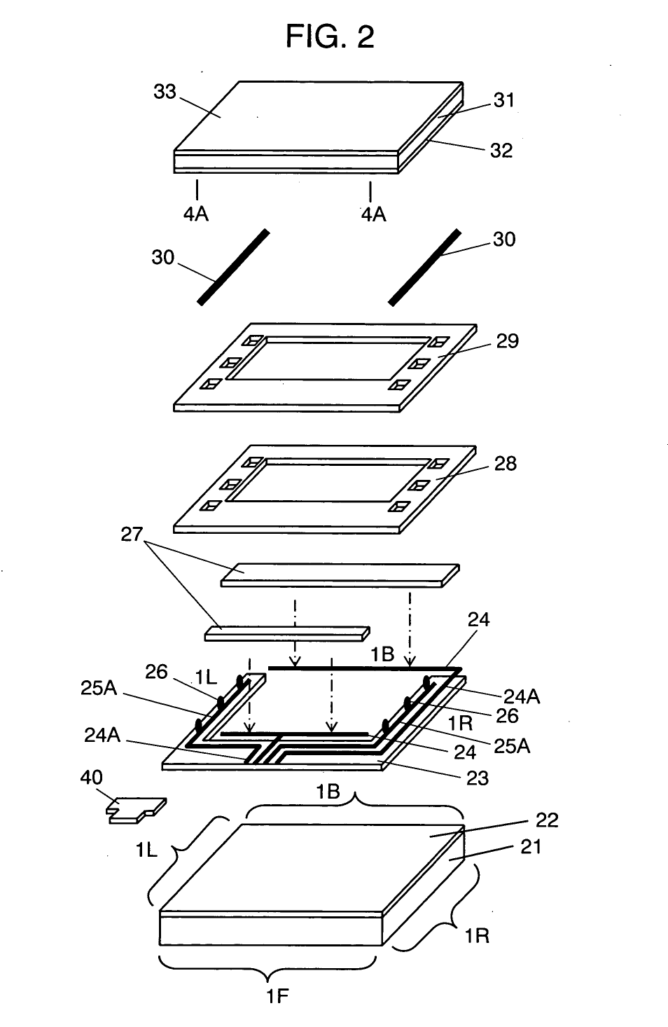

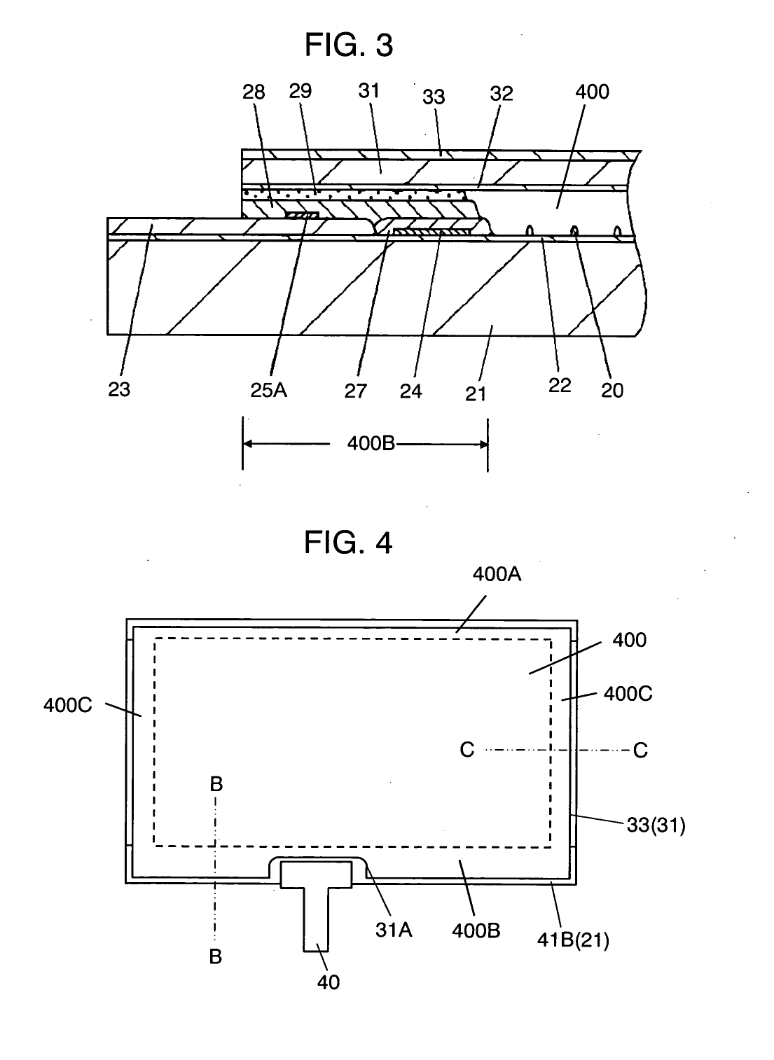

FIG. 1 is a top view of touch panel in a first exemplary embodiment of the invention, FIG. 2 is its perspective exploded view, and FIG. 3 is a sectional view along line A-A in FIG. 1.

On the upside of first transparent substrate 21 made of soda glass of rectangular shape, first transparent conductive film 22 of ITO or the like is formed on the entire surface. In touch panel operation region 400 disposed nearly in the center of first transparent conductive film 22, dot spacers 20 of small size made of insulating epoxy resin are formed at specific intervals.

On the entire downside of second transparent substrate 31 of rectangular shape, second transparent conductive film 32 of ITO is formed. The material of second transparent conductive film 32 is, for example, biaxially drawn polyethylene terephthalate film, and its thickness is 188 μm.

Second transparent conductive film 32 is disposed oppositely to first transparent substrate 21 and second transparent substrate 31 so as to maintain an interval of about 20 to 500 μm against first transparent conductive film 22, and these transparent substrates are adhered with each other by means of marginal outer circumferential parts 400A, 400B, and 400C. Herein, the “marginal outer circumferential parts” maybe defined to be a region excluding touch panel operation region 400 of the touch panel in FIG. 1. Or, explaining the marginal outer circumferential parts by referring to FIG. 3, it may be defined to be a confronting portion of first transparent substrate 21 and second transparent substrate 31 of the touch panel, being a region excluding touch panel operation region 400. The “marginal outer circumferential parts” are defined by the shape and size of overcoat resist 28 and adhesive layer 29 as “marginal members” as understood from FIG. 2 and FIG. 3.

The common term “marginal” of “marginal outer circumferential parts” and “marginal members” may be expressed as “surrounding.” Anyway, in the invention, “marginal” or “surrounding” is not limited to the expression of continuous and consecutive form of frame parts. The concept of “marginal” in the invention includes a partially disconnected outer circumference in order to prevent deformation of shape of touch panel or absorb stress, and formation of slits in shape in part of the frame outer circumference.

Incidentally, the upside of second transparent substrate 31 as the touch panel operation side is touched by pen or finger, and the shape of second transparent substrate 31 may be deformed or scratched. To avoid such damage, hard coat layer 33 of pencil hardness of about 3 H made of acrylic resin is formed on the top of second transparent substrate 31.

FPC 40 has a connector function for electrically connecting first transparent conductive film 22 and second transparent conductive film 32. More specifically, a flexible wiring board is used. FPC 40 is adhered and fixed nearly to the central position of an outer side of first transparent substrate 21.

As shown in FIG. 1, second transparent substrate 31 is formed in a rectangular shape, smaller than the width of first transparent substrate 21 by the portion of the width for installing FPC 40. FPC 40 is mounted on first transparent substrate 21 with its entire upside being exposed upward.

By front view of FIG. 2, on first transparent conductive film 22, undercoat resist layers 23 of epoxy resin are formed in U-shape on front end 1F and left and right ends 1L, 1R. Undercoat resist layer 23 maybe either single layer or multilayer structure.

Pair of electrodes 24 are disposed linearly and parallel to each other on first transparent conductive film 22. One of electrodes 24 is disposed at front end 1F of U-shaped undercoat resist layer 23, and other one at rear end 1R of first transparent substrate 21.

Wiring patterns 24A extending from pair of electrodes 24 are distributed on undercoat resist layer 23, and gathered in front central position of first transparent substrate 21 as the installation position of FPC 40, and the end portions are drawn out toward front end 1F.

The materials for electrode 24 and wiring pattern 24A both contain silver powder and polyester resin. Wiring patterns 25A are also disposed at both left and right sides 1L, 1R on undercoat resist layer 23. Wiring patterns 25A are further distributed on undercoat resist layer 23, and gathered in the front central position of first transparent substrate 21, and the end portions are drawn out toward front end portion 1F.

Wiring patterns 25A are prepared for second transparent conductive film 32. Wiring patterns 25A, like electrodes 24 and wiring patterns 24A, include silver powder and polyester resin. Further, on wiring patterns 25A formed on sides 1L, 1R of undercoat resist layer 23, electric connection conductors 26 similarly containing silver powder and polyester resin are disposed at several positions each. The material for composing electric connection conductors 26 may be nearly same as in wiring patterns 25A. Electric connection conductors 26 are also disposed at several positions each.

Insulating layer 27 shown in FIG. 2 and FIG. 3 covers a position not forming undercoat resist layer 23, on electrodes 24 at lower position than other wiring patterns 24A. The reason of disposing insulating layer 27 is for correcting the so-called step difference. That is, it is formed linearly on each electrode 24 in order to align the height position of film thickness uniformly.

By forming insulating layer 27, the height of undercoat resist layer 23 placed outside on first transparent conductive film 22 and height of insulating layer 27 can be nearly equalized. That is, the step difference can be corrected.

On marginal outer circumferential part 400 B, in order to keep insulation, overcoat resist layer 28 composed of epoxy resin as one of marginal members is disposed, and further acrylic adhesive layer 29 as another marginal member is overlaid. Such marginal members are disposed except for the location of electric connection conductor 26 and location of FPC 40 as clear from FIG. 2.

In this way, by forming insulating layer 27 and disposing adhesive layer 29 after correcting step difference and unifying the film thickness, the height of adhesive layer 29 as one of marginal members may be made uniform including the portions on electrodes 24.

Inside of marginal outer circumference 400B, as mentioned above, rectangular touch panel operation region 400 is present, and dot spacers 20 are formed in this touch panel operation region 400.

On the other hand, on second transparent conductive film 32 of second transparent substrate 31, linear electrodes 30 containing silver powder and polyester resin are formed parallel individually to right and left side ends 4A, 4A.

Second transparent conductive film 32 is adhered on adhesive layer 29 formed on the highest layer outside of first transparent substrate 21, and second transparent substrate 31 forming electrode 30 is adhered and fixed while keeping a specified interval to first transparent substrate 21.

FPC 40 has a wiring part in its lower side, and this wiring part is heat-sealed by way of anisotropic conductive film or the like, and electrically and mechanically mounted on upper exposed portion of the end of wiring patterns 24A and 25A gathered in the front central part on undercoat resist layer 23.

The manufacturing method of the touch panel is explained by referring to FIG. 2.

First, on the surface of first transparent substrate 21, first transparent conductive film 22 made of ITO or the like is formed by sputtering or other method. On the other hand, on second transparent substrate 31, barcode layer 33 is formed by applying a paint mainly composed of acrylic resin on the upside, and second transparent conductive film 32 is formed by sputtering or other method on the underside.

On first transparent conductive film 22 of first transparent substrate 21, in the portion corresponding to touch panel operation region 400, dot spacers 20 are formed, for example, by screen printing. Further, on marginal outer circumferential part 400B outside of touch panel operation region 400, undercoat resist layer 23, electrodes 24, wiring patterns 24A, 25A, and insulating layer 27 for correction of film thickness difference are printed and formed.

Overcoat resist layer 28, one of marginal members, is overlaid on marginal outer circumferential part 400B uniform in film thickness by forming insulating layer 27 for step difference correction, and further thereon adhesive layer 29, another marginal member, is formed by printing.

At this time, the marginal members, overcoat resist layer 28 and adhesive layer 29, are same in width in the whole circumference, and are also almost uniform in height.

On the other hand, on second transparent electrode 32 of second transparent substrate 31, electrodes 30 are printed and formed at left and right sides 1L, 1R.

When printing these layers and patterns, by using glass and film of larger size, a multiplicity of individual touch panels may be disposed in a plane in mass production.

First transparent substrate 21 of glass is scribed and cut off. Second transparent substrate 31 of polyethylene terephthalate is cut into individual touch panel sizes. In succession, first transparent substrate 21 and second transparent substrate 31 are glued together, with first transparent conductive film 22 and second transparent conductive film 32 face to face by way of touch panel operation region 400.

As outer circumference pressing process to reinforce the adhesion of marginal outer circumferential parts 400A, 400B and 400C of touch panel, the outer circumference of second transparent substrate 31 is pressed by a jig set at specified temperature with a specified pressure.

At this time, adhesive layer 29 is printed and formed in a uniform thickness in the entire width around marginal outer circumferential parts 400A, 400B and 400C shown in FIG. 1. In the pressing process using the pressing jig, uniform heat and pressure can be applied to the adhesive layer 29, and the entire circumference of the marginal members can be adhered uniformly and securely. At the same time, the number of manufacturing processes can be curtailed.

In next step, after the agent process for stabilizing the surface smoothness, FPC 40 is heat-sealed by using an anisotropic film in the disposing area of FPC 40 of first transparent substrate 21, and a touch panel is completed.

The touch panel of the invention is very firm in adhesion state in spite of the same size of marginal outer circumferential parts, that is, same width in the adhesion portion as in the prior art, and therefore the assembling process can be continued in stable state after the aging process.

Moreover, heat transmission to marginal outer circumferential parts at the time of heat sealing of FPC 40, and effects of stress can be lessened, so that a high quality with a good appearance can be obtained.

Adhesion state of first transparent substrate 21 and second transparent substrate 31 in the marginal outer circumferential parts is stronger in the whole periphery of marginal outer circumferential parts than in the prior art, and the reliability is assured if the width of adhesive layer 29 is narrow.

When using the touch panel of the first exemplary embodiment, same as in the prior art, by pressing the specified position of the operation region by finger or pen from above second transparent substrate 31, part of second transparent substrate 31 is deflected downward mainly in the operated portion.

By partial contact between first transparent conductive film 22 and second transparent conductive film 32, the voltage ratio at the contact point is taken out through FPC 40, and it is detected by an external circuit. At this time, the region except touch panel operation region 400 is defined by dot spacers 20, and contact-free state is maintained between first transparent conductive film 22 and second transparent conductive film 32 same as in the prior art.

An example of actual size of use of touch panel in the first exemplary embodiment is explained below.

At the present, the most common size of touch panel used in electronic device is for use in 7-inch liquid crystal panel (about 170 mm×110 mm).

An actual size of touch panel is set at 2 to 8 mm at right and left side width, 4 to 8 mm at front side, and 1.5 to 4 mm at rear side in the marginal outer circumferential parts of electric connection conductor 26. Electric connection conductor 26 is set in a square of 1 to 1.5 mm, and the width of adhesive layer 29 is set at 2 to 8 mm according to the width of outer circumference of the side of electric connection conductor 26.

The fabricated touch panel was tested in three environmental conditions, that is, high temperature and high humidity condition of 60° C. and 95% RH, high temperature condition of 95° C., and low temperature condition of −40° C., for more than 1,000 hours. In the heat cycle test, a cycle of 30 minutes at −40° C. and 30 minutes at 85° C. was repeated 1,000 times. After these environmental tests, the resistance between electrode terminals of touch panel, linearity, and other principal electric characteristics were measured. As a result, significant deterioration was not observed in the resistance between electrode terminals of touch panel, linearity, and other principal electric characteristics. The surface smoothness of hard coat layer 33 existing on the top of second transparent substrate 31 presented for touch panel operation was not changed from the initial state, and notable deterioration was not found from the viewpoint of visual recognition, controllability and quality. Environmental tests in same conditions were attempted in liquid crystal panels of 10 to 15 inch size, and similar favorable results were obtained.

These favorable tests results owe much to the provision of insulating layer 27 for uniform film thickness, that is, elimination of step difference of inside of touch panel of marginal outer circumferential parts by the presence of adhesive layer 29. As a result of elimination of step difference, the adhesion strength of first transparent substrate 21 and second transparent substrate 31 is adhesion, and strong and secure adhesion is realized. By enhancing the adhesion strength, the touch panel of the invention is excellent in surface smoothness and environmental resistance. The touch panel free from such step difference is particularly excellent in stress absorption and stress relaxation in the thickness direction.

The material of first transparent substrate 21 is not limited to soda glass, but includes methacrylic resin, polyolefin resin, polycyclohexadiene resin, norbornene resin, and other resin sheets formed by general extrusion molding, casting molding, or injection molding. It is also possible to use biaxially drawn polyester film, polycarbonate film, and other films, and anyway the thickness is preferred to be 0.1 to 10 mm, preferably 0.15 to 3 mm.

The material of second transparent substrate 31 is not limited to biaxially drawn polyethylene terephthalate, but includes biaxially drawn polyethylene naphthalate, uniaxially drawn polyethylene terephthalate, other drawn films, and polycarbonate and polyolefin films by casting. The thickness is preferred to be 0.01 to 0.4 mm, more practically 0.025 to 0.2 mm.

The material of first transparent conductive film 22 and second transparent conductive film 32 includes ITO, tin oxide (SnO₂), zinc oxide (ZnO), gold (Au) thin film, silver (Ag) thin film, etc. They can be formed by sputtering method, CVD (chemical vapor deposition) method, vacuum deposition method, ion plating method, and coating and baking method of metal organic matter.

The material of undercoat resist layer 23, overcoat resist layer 28, and insulating layer 27 for uniform film thickness includes epoxy resin, acrylic resin, polyester resin, urethane resin, phenol resin, or combination thereof. Anyway it is important to select a material excellent in adhesion to the printed side.

The material of electrodes 24, 30, wiring patterns 24A, 25A, and electric connection conductor 26 includes silver powder, polyester resin, conductive powder such as mixed powder of silver powder and carbon powder, copper powder, gold powder, etc. Resin components include epoxy system, phenol system, acrylic system, urethane system, and others, which may be selected properly in consideration of the electric resistance, adhesion strength, dispersion of conductive powder, and environmental resistance.

The forming method of layers for composing the marginal outer peripheral parts includes screen printing, offset printing, ink coating method, ink patterning coating method by scribing head, etc.

To form electric connection conductor 26 requiring a film thickness of 100 μm or more, an ink filling method by dispenser may be also employed. As adhesive layer 29, a double-sided adhesive tape may be adhered and processed in a pattern.

Insulating layer 27 for step difference correction to realize a uniform film thickness is preferably formed in a same height as undercoat resist layer 23. However, similar effects are obtained as far as the difference is in a range of ±10 to 20 μm from the film thickness of undercoat resist layer 23.

When insulating layer 27 is printed before forming overcoat resist layer 28, preferably, the height position of adhesive layer 29 is stable by way of overcoat resist layer 28. Or, by printing overcoat resist layer 28 first, insulating layer 27 for correcting step difference may be formed thereon, and adhesive layer 29 may be disposed on the insulating layer with part of overcoat resist layer 28.

The etching-free type disposing transparent conductive film on the entire surface of substrate is shown, but if other parts are removed by etching, leaving the transparent conductive film in the touch panel operation region and specified region in the outside, an excellent adhesion stability between substrates may be easily obtained by composing the marginal outer circumferential parts including he insulating film for step difference correction for uniform film thickness.

### Second Exemplary Embodiment

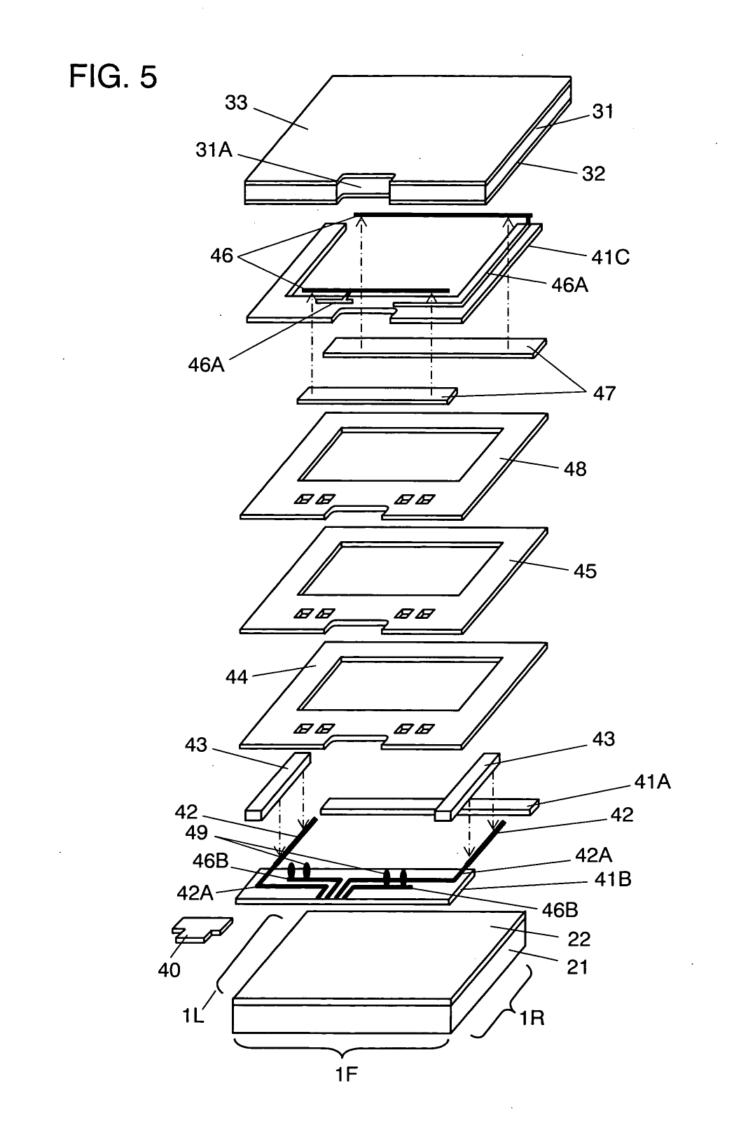

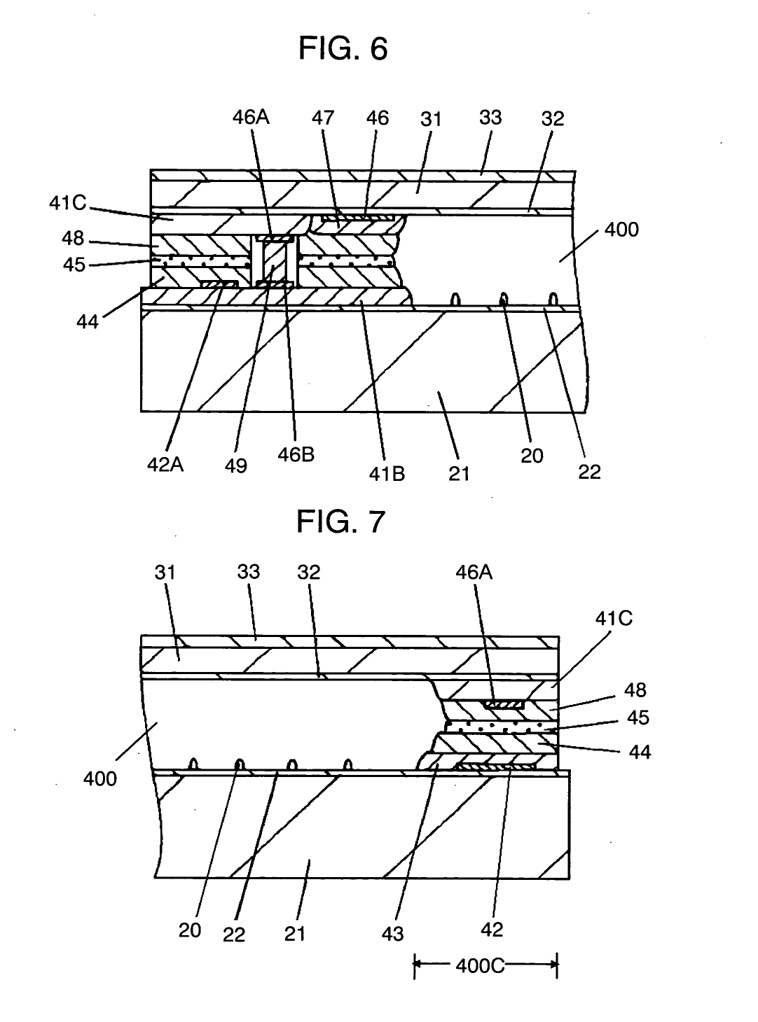

FIG. 4 is a top view of touch panel in a second exemplary embodiment of the invention, FIG. 5 is its perspective exploded view, FIG. 6 is a sectional view along line B-B in FIG. 4, and FIG. 7 is a sectional view along line C-C in FIG. 4.

Same parts as in the first exemplary embodiment shown in FIG. 1 to FIG. 3 are identified with same reference numerals, and their explanation is omitted.

In the touch panel of the second exemplary embodiment, same as in the first exemplary embodiment, first transparent substrate 21 and second transparent substrate 31 are adhered with first transparent conductive film 22 and second transparent conductive film 32 face to face across a specific interval, and adhered and fixed with marginal outer circumferential parts 400A, 400B, and 400C. At the front side, FPC 40 is adhered same as in the first exemplary embodiment.

Second transparent substrate 31 has, as shown in FIG. 4, a rectangular shape of a nearly same size as first transparent substrate 21. In the position corresponding to the disposing part of FPC 40, a notch 31A slightly larger than the outer shape of FPC 40 is formed.

In the touch panel of the second exemplary embodiment, the composition of marginal outer circumferential parts 400A, 400B and 400C is different from that in the first exemplary embodiment, and this composition of marginal outer circumferential parts is explained.

As shown in FIG. 5, on first transparent conductive film 22 of first transparent substrate 21, undercoat resist layer 41A is disposed linearly to its rear end (opposite side of front end 1F described below), and undercoat resist layer 41B linearly to front end 1F, in a film thickness of 45 μm each.

At this time, undercoat resist layer 41B at front end 1F side includes FPC 40, and is hence formed in the same width as in the first exemplary embodiment.

Linear electrodes 42 are disposed parallel to each other at left and right sides 1L, 1R on first transparent conductive film 22 at opposite sides of undercoat resist layers 41A, 41B.

This pair of electrodes 42 are directly disposed on first transparent conductive film 22, and wiring pattern 42A extended from the front end of each electrode 42 is distributed on undercoat resist layer 41B and gathered in the front center, and the end portion is drawn out to the front end 1F side.

To cover each electrode 42, insulating layers 43 for correction of step difference for uniform film thickness are formed at left and right sides 1L, 1F, in a film thickness of 45 μm, so as to be at same height as undercoat resist layers 41A, 41B. These undercoat resist layers 41A, 41B and insulating layers 43 are formed in part of marginal outer circumferential parts 400A, 400B, and 400C. Overlaying on these marginal outer circumferential parts, overcoat resist layer 44 and adhesive layer 45 are formed.

On the other hand, at the side of second transparent substrate 31, undercoat resist layer 41C is formed in U shape in a film thickness of 45 μm, at the front and left and right sides on second transparent conductive film 32.

Further on second transparent conductive film 32, a pair of linear electrodes 46 are disposed directly. One electrode 46 of the pair of electrodes 46 is disposed at the front position in the region enclosed by U-shaped undercoat resist layer 41C, and other electrode 46 is disposed parallel at the rear end of substrate 31.

In such configuration of electrodes 46, by second transparent conductive film 32 which is no longer rectangular because of provision of notch 31A, effects of voltage application on linearity characteristics can be lessened. Wiring patterns 46A extended from electrodes 46 are distributed to the front central position of second transparent substrate 31 on undercoat resist layer 41C.

To cover electrodes 46, insulating layers 47 for step difference correction are formed in a film thickness of 45 μm, and marginal overcoat resist layers 48 are formed on the marginal outer circumferential parts uniform in height.

Wiring patterns 46B are formed on undercoat resist layer 41B of first transparent electrode 21, and each wiring pattern 46A is connected to each corresponding wiring pattern 46B by electric connection conductor 49 face to face in the vertical direction.

To install FPC 40, the outer side and front side of overcoat resist layers 44, 48 and adhesive layer 45 are formed in a sufficient breadth. Therefore, when electric connection conductor 49 is disposed therein, there is enough space for electric connection conductor 49, and the connection stability is enhanced. Wiring patterns 46B are gathered in the front central position of the broad area, and the end portion is drawn out toward front end 1F.

In the location of electric connection conductor 49, holes are opened in the positions for forming electric connection conductors 49 for overcoat resist layers 44, 48 and adhesive layer 45. This structure is same as in the first exemplary embodiment. Adhesive layer 45 is adhered to overcoat resist layer 48, and first transparent substrate 21 and second transparent substrate 31 are adhered and fixed in mutually facing state.

The material of overcoat resist layers 44, 48 and adhesive layer 45 for composing marginal members is same as in the first exemplary embodiment.

The lower wiring portion (not shown) of FPC 40 is heat-sealed and adhered to the ends of wiring patterns 42A and 46B gathered at the front end 1F of first transparent substrate 21 within notch 31A. At this time, the upside of FPC 40 may be exposed, and setting of heat seal condition is easy, and working efficiency of adhesion is excellent, same as in the first exemplary embodiment.

Also at the downside of overcoat resist layer 48, adhesive layers may be disposed in a margin and adhesive layers may be adhered to each other. In this case, a more reliable adhesion may be obtained more easily, and the reliability is further enhanced.

In the touch panel of the second exemplary embodiment having such constitution, by effectively utilizing the broad section provided in the FPC 40, in marginal outer circumferential parts 400A, 400B and 400C for adhering first transparent substrate 21 and second transparent substrate 31, the width can be set narrower in other parts excluding the area of FPC 40, and hence the area is substantially increased in the touch panel operation region.

In this constitution, too, since the marginal outer circumferential parts include insulating layer 43 for step difference correction and insulating layer 47, if the width of the outer circumference is narrow, the adhesion state of first transparent substrate 21 and second transparent substrate 31 is stable, and the touch panel excellent in surface smoothness and environmental resistance can be realized.

The operation and manufacturing method of touch panel are same as in the first exemplary embodiment, and the explanation is omitted.

The touch panel in the second exemplary embodiment was fabricated in an actual size, for use in 7-inch liquid crystal panel (about 170 mm×110 mm). Specifically, the width of front outer side of FPC 40 and electric connection conductor 49 is set at 4 to 8 mm, the width of other side at 1.5 to 4 mm, the size of electric connection conductor 49 at 1 to 1.5 mm square, and the width of adhesive layer 45 at 4 to 8 mm conforming to the front side of outer circumference of electric connection conductor 49.

The fabricated touch panel was tested in three environmental conditions, that is, high temperature and high humidity condition of 60° C. and 95% RH, high temperature condition of 95° C., and low temperature condition of −40° C., for more than 2,000 hours. In the heat cycle test, a cycle of 30 minutes at −40° C. and 30 minutes at 85° C. was repeated 2,000 times. After these environmental tests, the resistance between electrode terminals of touch panel, linearity, and other principal electric characteristics were measured. As a result, significant deterioration was not observed in the resistance between electrode terminals of touch panel, linearity, and other principal electric characteristics. The surface smoothness of second transparent substrate 31 presented for touch panel operation was not changed from the initial state, and notable deterioration was not found from the viewpoint of visual recognition, controllability and quality. Environmental tests in same conditions were attempted in liquid crystal panels of 10 to 15 inch size, and similar favorable results were obtained.

Materials for first transparent substrate 21, second transparent substrate 31, and layers for composing marginal outer circumferential parts may be same as in the first exemplary embodiment. Necessary portions of transparent conductive films may be left over by etching, or the electrodes may be disposed in the same layout as in the first exemplary embodiment.

### Third Exemplary Embodiment

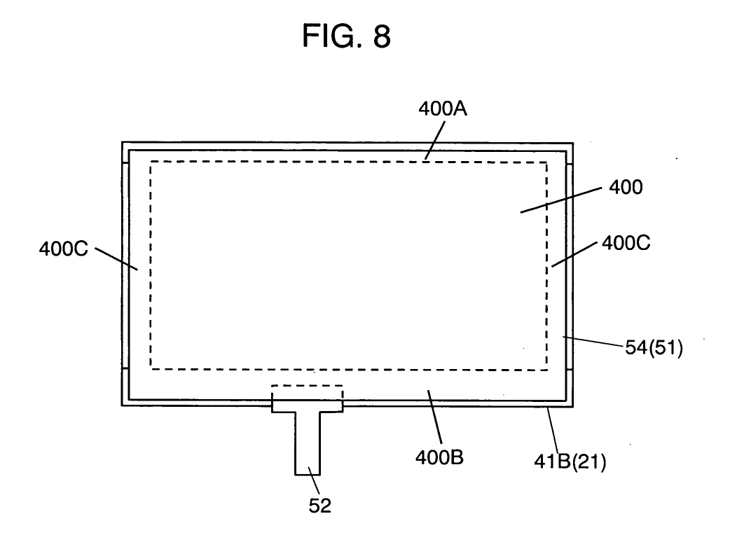

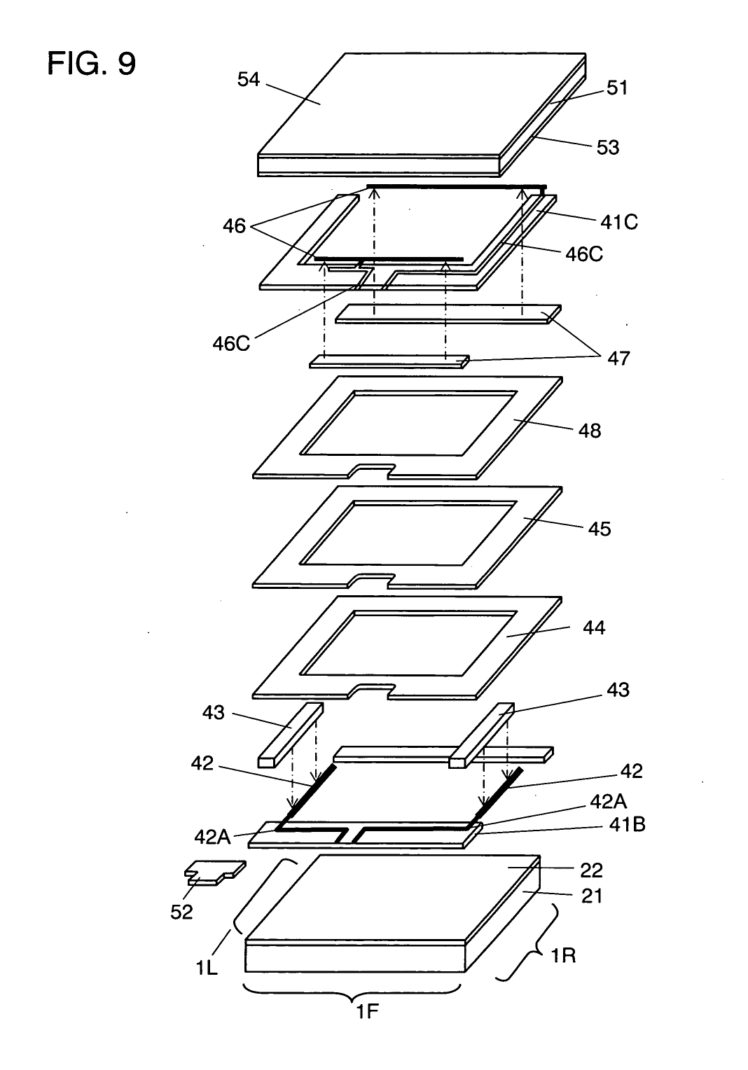

FIG. 8 is a top view of touch panel in a third exemplary embodiment of the invention, and FIG. 9 is its perspective exploded view. As compared with the second exemplary embodiment, the touch panel of the third exemplary embodiment is different in the installation state of FPC 52. Same parts as in the second exemplary embodiment are identified with same reference numerals, and their explanation is omitted.

In the entire surface of downsize of second transparent substrate 51 made of polyethylene terephthalate, second transparent conductive film 53 is formed, and hard coat layer 54 is formed on the entire surface of its upside. Second transparent substrate 51 has a rectangular shape having no notch or disposing FPC 52. Second transparent substrate 51 is disposed face to face with first transparent substrate 21 so as to overlap in a specified portion on FPC 52 adhered and fixed on first transparent conductive film 22 formed on first transparent substrate 21.

Same as in the second exemplary embodiment, first transparent substrate 21 and second transparent substrate 51 are adhered and fixed stably by means of marginal outer circumferential parts 400A, 400B and 400C including insulating layers 43, 47 disposed for uniform film thickness.

In the third exemplary embodiment, as compared with the second exemplary embodiment, the distribution state of wiring patterns is different in marginal outer circumferential parts 400A, 400B and 400C. That is, as shown in FIG. 9, on undercoat resist layer 41B disposed at front end 1F on first transparent substrate 21, only wiring patterns 42A extended from each electrode 42 disposed at left and right sides 1L, 1R are distributed. These two wiring patterns 42A are gathered at the front central position of first transparent substrate 21, and end portions are extended toward front end 1F.

Wiring patterns 46C extended from electrodes 46 disposed at front and rear sides of second transparent substrate 51 are distributed on undercoat resist layer 41C, and gathered in the front central position of second transparent substrate 51, and end portions are extended toward front end 1F.

FPC 52 is so-called double-sided substrate type. Wiring parts are provided on upside and downside, and are respectively connected electrically to wiring pattern 46C and wiring pattern 42A.

Overcoat resist layers 44, 48 and adhesive layer 45 are disposed so as to evade the positions corresponding at least to the wiring positions of FPC 52.

In this configuration, since electric connection conductor is not needed, the hole for releasing electric connection conductor is not needed in overcoat resist layers 44, 48 and adhesive layer 45, and each pattern can be formed easily. In the outer front position, only wiring patterns 46C, 42A are disposed in upper and lower positions, and as compared with the second exemplary embodiment, the width can be formed narrowly in marginal outer circumferential part 400B corresponding to the front position of the touch panel, and the space is further saved in the marginal outer circumferential parts.

In this configuration, too, since first transparent substrate 21 and second transparent substrate 51 are adhered and fixed to each other by adhesive layer 45 disposed on marginal outer circumferential parts corrected in step difference by forming insulating layer 43 and insulating layer 47, the reliability is assured in spite of the touch panel of narrow marginal edge.

In the touch panel of the third exemplary embodiment, since notch for disposing FPC 52 is not formed in second transparent substrate 51, first transparent substrate 21 and second transparent substrate 51 are glued together so as to include FPC 52. In the aspect of management of heat seal condition and working efficiency in the gluing process, however, it is slightly inferior to that of the touch panel in the first exemplary embodiment and second exemplary embodiment. However, the compression section of FPC 52 can be protected by first transparent substrate 21 and second transparent substrate 51. Moreover, since FPC 52 is enclosed by first transparent substrate 21 and second transparent substrate 51 stable in adhesion fixing state, the adhesion state of FPC 52 is also stable.

In second transparent substrate 51, moreover, since second transparent conductive film 53 distributed on the entire surface remains to be a rectangular shape, and electrodes 46 are not required to be located at front and rear positions, and the degree of freedom of design is extended.

In the touch panel of the third exemplary embodiment characterized by the structure of including FPC 52, in consideration of thickness of FPC 52, it is preferred to set the thickness of undercoat resist layers 41B, 41C corresponding to the region of disposing range of FPC 52 and insulating layer 47 and others for uniform film thickness.

To mount on an actual liquid crystal panel of 7-inch size, the touch panel of the third exemplary embodiment was fabricated in a size of 170 mm×110 mm. At this time, the width of front outer side for disposing FPC 52 is set at 3 to 4 mm conforming to narrow margin type, and the width of other sides is set at 1.5 to 3 mm.

The fabricated touch panel was tested in three environmental conditions, that is, high temperature and high humidity condition of 60° C. and 95% RH, high temperature condition of 95° C., and low temperature condition of −40° C., for more than 2,000 hours. In the heat cycle test, a cycle of 30 minutes at −40° C. and 30 minutes at 85° C. was repeated 2,000 times. After these environmental tests, the resistance between electrode terminals of touch panel, linearity, and other principal electric characteristics were measured. As a result, significant deterioration was not observed in the resistance between electrode terminals of touch panel, linearity, and other principal electric characteristics. The surface smoothness of second transparent substrate presented for touch panel operation was not changed from the initial state, and notable deterioration was not found from the viewpoint of visual recognition, controllability and quality.

The structure of including FPC 52 between upper and lower substrates of first transparent substrate 21 and second transparent substrate 51 in the third exemplary embodiment can be also applied in the first exemplary embodiment and second exemplary embodiment.

### Fourth Exemplary Embodiment

A fourth exemplary embodiment is similar to the second exemplary embodiment, but is improved in the optical characteristics. Same parts as in the touch panel of the second exemplary embodiment are identified with same reference numerals, and their explanation is omitted.

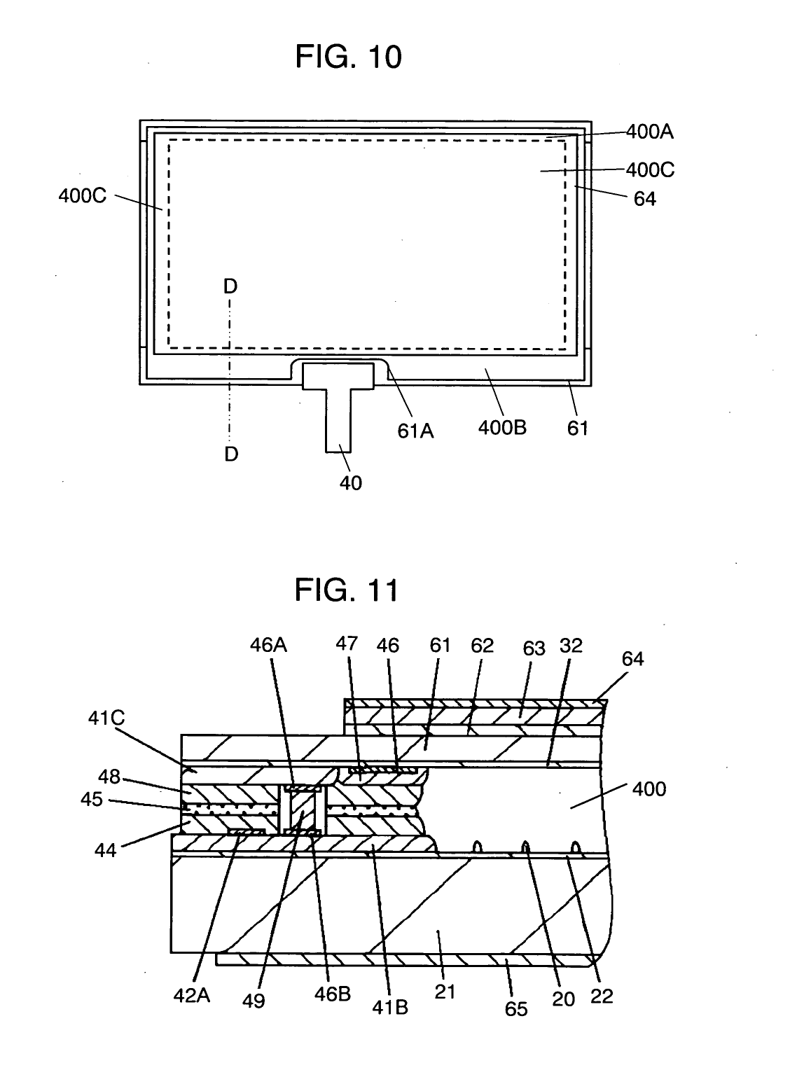

FIG. 10 is a top view of touch panel in the fourth exemplary embodiment of the invention, and FIG. 11 is a sectional view along line A-A in FIG. 10.

In FIG. 10 and FIG. 11, second transparent substrate 61 is composed of polycarbonate of about 100 μm in thickness formed by, for example, casting method. In the entire surface of downside of second transparent substrate 61, second transparent conductive film 32 of ITO is formed. First transparent substrate 21 and second transparent substrate 61 are adhered with marginal outer circumferential parts 400A, 400B and 400C so as to keep an interval of about 50 to 300 μm between second transparent conductive film 32 and first transparent conductive film 22.

Second transparent substrate 61 has notch 61A, and within its region, FPC 40 is adhered to first transparent substrate 21 with its the upside in exposed state, same as in the second exemplary embodiment.

On the upside of second transparent substrate 61, quarter wavelength phase difference plate 62 and polarizer 63 are laminated and integrated. Since the upside of polarizer 63 is exposed to operation by pen or finger, it may be deformed or damaged. To prevent such flaw, the upside of polarizer 63 is protected with hard coat layer 64 of pencil hardness of about 3H composed of protective acrylic resin or the like.

On the other hand, on the downside of first transparent substrate 21 made of soda glass, quarter wavelength phase difference plate 65 varied in axial angle by 90° from quarter wavelength phase difference plate 62 is adhered.

The other structure is same as in the touch panel of the second exemplary embodiment, and the explanation is omitted. In this constitution, too, marginal outer circumferential parts 400A, 400B, and 400C for adhering first transparent substrate 21 and second transparent substrate 61 in opposite state are composed by including insulating layer 47 for step difference correction for uniform film thickness (insulating layer 43 shown in FIG. 9 is not shown). Thus, first transparent substrate 21 and second transparent substrate 61 are stably held in adhered state.

The fabricated touch panel was tested in three environmental conditions, that is, high temperature and high humidity condition of 60° C. and 95% RH, high temperature condition of 95° C., and low temperature condition of −40° C., for more than 1,000 hours. In the heat cycle test, a cycle of 30 minutes at −40° C. and 30 minutes at 85° C. was repeated 1,000 times.

After these environmental tests, the resistance between electrode terminals of touch panel, linearity, and other principal electric characteristics were measured. As a result, significant deterioration was not observed in the resistance between electrode terminals of touch panel, linearity, and other principal electric characteristics. The surface smoothness of second transparent substrate presented for touch panel operation was not changed from the initial state, and notable deterioration was not found from the viewpoint of visual recognition, controllability and quality.

Above second transparent substrate 61, quarter wavelength phase difference plate 62 and polarizer 63 are laminated in this sequence. Further, quarter wavelength phase difference plate 65 is provided at the downside of first transparent substrate 21, and therefore reflection of ray at the interface of substrate of touch panel is decreased. In the second exemplary embodiment, the reflectivity of the touch panel was about 13%, and it is decreased to about 5% in the fourth exemplary embodiment.

In the touch panel of the fourth exemplary embodiment, the entire surfaces of quarter wavelength phase difference plate 62 and polarizer 63 are glued together, and laminated on second transparent substrate 61. Accordingly, in marginal outer circumferential parts 400A, 400B and 400C, first transparent substrate 21 and second transparent substrate 61 are fixed at high adhesion strength. As a result, if quarter wavelength phase difference plate 62 or polarizer 63 is warped, its degree of effect is decreased.

As second transparent substrate 61, aside from polycarbonate film by casting method, other film of less optical phase difference may be used, such as polyolefin film (Arton of JSR Co.) or polyallylate film. The thickness of such film is 0.01 to 0.4 mm, preferably 0.025 to 0.2 mm.

As first transparent substrate 21, aside from soda glass, other film of less optical phase difference may be used, such as polycarbonate film, polyolefin film or polyallylate film by casting method. The thickness of such film is 0.1 to 10 mm, preferably 0.15 to 3 mm.

Quarter wavelength phase difference plate 62 and polarizer 63 adhered on the upside of second transparent substrate 61 are not always required to be of same size as second transparent substrate 61. It is enough as far as sufficient touch panel operation region 400 can be assured.

Similarly, quarter wavelength phase difference plate 65 adhered to the downside of first transparent substrate 21 is enough as far as specified touch panel operation region 400 can be assured

Incidentally, quarter wavelength phase difference plate 65 adhered to the downside of first transparent substrate 21 may be adhered to the upside of liquid crystal display device or organic EL element disposed on the downside of the touch panel., instead of the downside of first transparent substrate 21.

Besides, by removing quarter wavelength phase difference plates 62, 65, only polarizer 63 may be adhered on second transparent substrate 61. By experiment, in this configuration, the reflectivity of the touch panel was about 9%. As compared with the composition having both phase difference plates 62, 65, the reflectivity is inferior, but the cost is lower than in the second exemplary embodiment. Similar effects as mentioned above can be obtained by using circular polarizer.

### Fifth Exemplary Embodiment

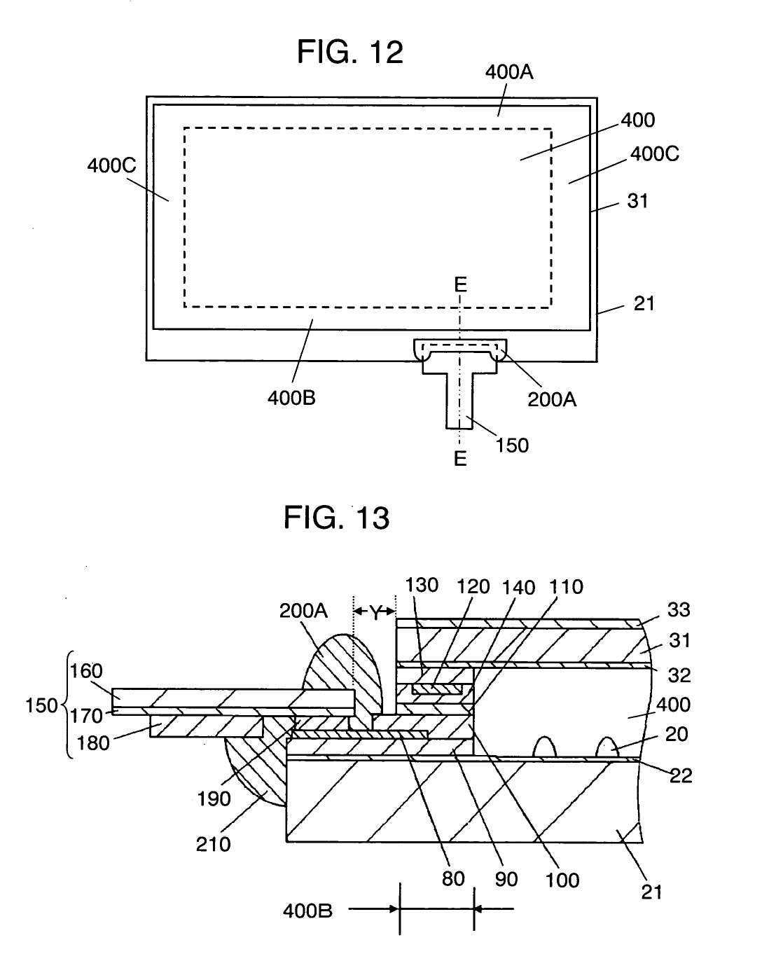

FIG. 12 is a top view of touch panel in a fifth exemplary embodiment of the invention, and FIG. 13 is a sectional view along line E-E in FIG. 12.

In FIG. 12 and FIG. 13, first transparent conductive film 22 of ITO or the like is formed on the entire surface of upside of first transparent substrate 21 of soda glass. In touch panel operation region 400 on first transparent conductive film 22, dot spacers 20 of small size of insulating epoxy resin are formed at specified pitches.

Second transparent conductive film 32 of ITO is formed on the entire downside of second transparent substrate 31 of biaxially drawn polyethylene terephthalate film of 188 μm in thickness.

First transparent substrate 21 and second transparent substrate 31 are adhered outside of touch panel operation region 400, that is, in marginal outer circumferential parts 400A, 400B and 400C. First transparent conductive film 22 and second transparent conductive film 32 are disposed face to face in insulated state at an interval of about 20 to 500 μm.

The upside of second transparent substrate 31 is coated with hard coat layer 33 of pencil hardness of about 3 H of acrylic resin so as not to be scratched during operation by pen or finger.

In the adhesion section of first transparent substrate 21 and second transparent substrate 31, that is, in marginal outer circumferential part 400B (400A, 400C), wiring by printed and dried film of conductive paint having silver powder dispersed in the resin, electrode for supplying voltage to transparent conductive film (hereinafter called wiring and electrode pattern) 80, insulating undercoat resist layer 90, overcoat resist layer 100, and adhesive layer 110 for adhering and fixing first transparent substrate 21 and second transparent substrate 31 are formed in specified patterns.

At the side of second transparent substrate 31, similarly, outside of touch panel operation region 400, that is, in marginal outer circumferential part 400B, wiring and electrode pattern 120, insulating undercoat resist layer 130, and overcoat resist layer 140 are composed.

FPC 150 is a kind of connector for transmitting a lead-out signal drawn from first transparent conductive film 32 and second transparent conductive film 34 to an external circuit (not shown) More specifically, flexible wiring printed circuit is used. The material of base film 160 for composing FPC 150 is polyimide, and wiring pattern 170 disposed in a plurality of specified patterns at one side is composed of gold-plated copper foil, and it further includes a cover lay 180 of polyimide for covering parts not to be exposed of each wiring pattern 170.

Herein, FPC 150 is adhered and fixed by thermal compression to the outer end of the upside of first transparent substrate 21 by way of anisotropic conductive film 190 mainly composed of epoxy resin and gold plated resin beads, and its tail is connected to the external circuit (not shown).

At this time, in the fixed state of FPC 150, the end portion of each wiring pattern 170 is electrically connected to wiring and electrode patterns 80 and 120 byway of anisotropic conductive film 190.

Further, protective layers 200A and 210 are composed of wet curing silicone resin, and applied to the periphery of compression area of first transparent substrate 21 of FPC 150. Same as in the prior art, they are formed by coating by using a dispenser or the like for the purpose of reinforcing the adhesion of FPC 150, sulfurizing wiring and electrode pattern 80 of first transparent substrate 21 and wiring pattern 170 of FPC 150, and preventing migration.

FPC 150 is adhered and fixed to the side of first transparent substrate 21, but is cleared from second transparent substrate 31 by specific distance Y. The length of distance Y is preferred to be 2 mm or more. If distance Y is shorter than 2 mm, the end of FPC 150 and the end of second transparent substrate 31 may come into mutual contact due to fluctuations in manufacture. If they do not contact with each other, part of protective layer 200A may contact with part of the side of second transparent substrate 31.

The upper limit of distance Y is restricted by the size of frame outer periphery. For example, in the case of a touch panel of 15 inches, the size of the frame outer periphery is about 20 mm, and hence the upper limit of distance Y is 20 mm.

As shown in FIG. 13, the touch panel in the fifth exemplary embodiment is different from the prior art that protective layer 200A disposed at upside of first transparent substrate 21 is cured and formed without contacting with second transparent substrate 31.

A manufacturing method of touch panel in the fifth exemplary embodiment is described below.

First, on the surface of first transparent substrate 21, first transparent conductive film 22 of ITO is formed, for example, by sputtering method. On second transparent substrate 31, hard coat layer 33 coated with paint mainly composed of acrylic resin by roll coater is formed on one side, and second transparent conductive film 32 is formed by sputtering or other method on the reverse side.

Further, dot spacers 20, undercoat resist layers 90, 130, wiring and electrode patterns 80, 120, overcoat resist layers 100, 140, adhesive layer 110, and others are formed, for example, by printing method.

After forming these layers including adhesive layer 110, first transparent substrate 21 of glass is scribed in specified touch panel size, and cut off. Second transparent substrate 31 of polyethylene terephthalate is also cut off in specified shape.

First transparent substrate 21 and second transparent substrate 31 are adhered by means of adhesive layer 110 with first transparent conductive film 22 and second transparent conductive film 32 face to face. In order to reinforce the adhesion of the outer part of touch panel operation region 400, that is, marginal outer circumferential part 400B (400A, 400C), outer circumference pressing process is executed, together with aging process for stabilizing the surface smoothness. Then, FPC 150 is heat-sealed and adhered and fixed by using a tape of anisotropic conductive film 190 on the adhesion fixing portion of wiring and electrode pattern 80 on first transparent substrate 21.

Protective film 200A of silicone resin is applied around the upside of compression part of FPC 150, and protective layer 210 of acrylic resin is applied to end portion of first transparent substrate 21 around the rear side of compression part of FPC 150, by means of dispenser, and cured at ordinary temperature, and a touch panel is completed.

Application position and application amount of silicone resin are adjusted, in the process of applying the silicone resin, so that protective layer 200A may not contact with the end portion of second transparent substrate 31 after curing.

When using the touch panel of the fifth exemplary embodiment, hard coat layer 33 and second transparent substrate 31 are pressed from above at specified position by finger or pen. Second transparent substrate 31 is partially deflected downward mainly from the operated portion, and first transparent conductive film 22 and second transparent conductive film 32 contact with each other at this position. The voltage ratio at the contact point is drawn out through FPC 150, and it is detected by an external circuit (not shown). At this time, other parts than the operated portion are defined by dot spacers 20 and kept in contact-free state.

As the touch panel of the fifth exemplary embodiment, samples were fabricated in the size of 2 to 15 inches, and environmental tests were conducted. In the environmental tests, by keeping in the condition of high temperature and high humidity of 85° C. and 85% RH, for more than 2,000 hours, and the appearance and principal electric characteristics of touch panel were measured. As a result, the surface smoothness of second transparent substrate 31 of the touch panel was not spoiled. No deterioration was found in the resistance between electrode terminals, linearity and other characteristics of the touch panel.

Such favorable test results owe much to the action of protective layer 200A around FPC 150 disposed at the upside of first transparent substrate 21. That is, protective layer 200A does not contact with second transparent substrate 31 in structure, and it is estimated that adhesive layer 110 contributes to entire uniform relaxation of stress due to difference in coefficient of thermal expansion between first transparent substrate 21 and second transparent substrate 31.

That is, by composing protective layer 200A so as not to contact with second transparent substrate 31, even in the severe environment of high temperature and high humidity, partial defining portion of expansion state of second transparent substrate 31 can be eliminated, and the stress relaxation function by adhesive layer 110 seems to act in the same condition uniformly on the touch panel.

In other words, by the combined effects of protective layer 200A and adhesive layer 110, the effects of shape deformation prevention, stress absorption and stress relaxation in the thickness direction and width direction of the touch panel are encouraged.

Thus, the touch panel of the fifth exemplary embodiment is characterized by the excellent surface smoothness of second transparent substrate 31 hardly changing in spite of severe condition of use of high temperature and high humidity, and is excellent in visual recognition, controllability, and quality, and realizes a high durability withstanding severe environments of use.

The material of first transparent substrate 21, is not limited to soda glass, but includes methacrylic resin, polycyclo-olefin resin, polycyclohexadiene resin, norbornene resin, and other resin sheets formed by general extrusion molding, casting molding, or injection molding.

It is also possible to use biaxially drawn polyester film, polycarbonate film, and other films, and anyway the thickness is preferred to be 0.1 to 10 mm, preferably 0.15 to 3 mm.

The material of second transparent substrate 31 is not limited to biaxially drawn polyethylene terephthalate, but includes biaxially drawn polyethylene naphthalate, uniaxially drawn polyethylene terephthalate, other drawn films, and polycarbonate and polyolefin films by casting.

The thickness is preferred to be 0.01 to 0.4 mm, more practically 0.025 to 0.2 mm. The material of first transparent conductive film 22 and second transparent conductive film 32 includes ITO, tin oxide (SnO₂), zinc oxide (ZnO), gold (Au) thin film, silver (Ag) thin film, etc.

First transparent conductive film 22 and second transparent conductive film 32 can be formed by sputtering method, CVD (chemical vapor deposition) method, vacuum deposition method, ion plating method, and coating and baking method of metal organic matter.

The material of undercoat resist layers 90, 130 and overcoat resist layers 100, 140 includes epoxy resin, acrylic resin, polyester resin, urethane resin, phenol resin, or combination thereof. Anyway it is important to select a material excellent in adhesion to the printed side.

The material of electrode and wiring patterns 80, 120 includes silver powder, polyester resin, conductive powder such as mixed powder of silver powder and carbon powder, copper powder, gold powder, etc. Resin components include epoxy system, phenol system, acrylic system, urethane system, and others, which may be selected properly in consideration of the electric resistance, adhesion strength, dispersion of conductive powder, and environmental resistance.

The forming method of undercoat resist layers 90, 130, overcoat resist layers 100, 140, wiring and electrode patterns 80, 120, and adhesive layer 110 includes screen printing, offset printing, ink coating method, ink patterning coating method by scribing head, etc. As adhesive layer 110, a double-sided adhesive tape may be adhered and processed in a pattern.

The material of base material film 160 of FPC 150 and over lay 180 includes polyimide, polyethylene terephthalate, and others. Wiring pattern 170 is gold-plated copper foil, solder-plated copper foil, or conductive paste having silver powder dispersed in resin, being printed and cured.

Principal components of anisotropic conductive film 190 include epoxy resin, acrylic resin, gold-plated resin beads, solder-plated resin beads, ceramic beads, and metal particles.

Protective layers 200A, 210 are preferably made of materials excellent in adhesion to base material film 160 of FPC 150, overcoat resist layer 100 of first transparent substrate 21, and glass of first transparent substrate 21, and also excellent in humidity resistance. Aside from silicone resin, one of acrylic system, epoxy resin, and silicone denatured acrylic resin may be selected, or they may be properly combined.

In the fifth exemplary embodiment, FPC 150 is compressed to first transparent substrate 21, and protective layer 200A of upside of first transparent substrate 21 does not contact with second transparent substrate 31 in structure. However, same effects are obtained by compressing FPC 150 to second transparent substrate 31 side so that protective layer 200A provided around FPC compression area of second transparent substrate 31 may not contact with first transparent substrate 21.

The fifth exemplary embodiment, that is, protective layers 200A, 210 shown in FIG. 12 and FIG. 13 may be also applied to the structure of the touch panel shown in the first exemplary embodiment to the fourth exemplary embodiment.

That is, the structure may have the functions of both protective layers 200A, 210 and insulating layer 27. Such structure is effective in stress absorption and stress relaxation of shape deformation in the thickness direction ad width direction of the touch panel.

### Sixth Exemplary Embodiment

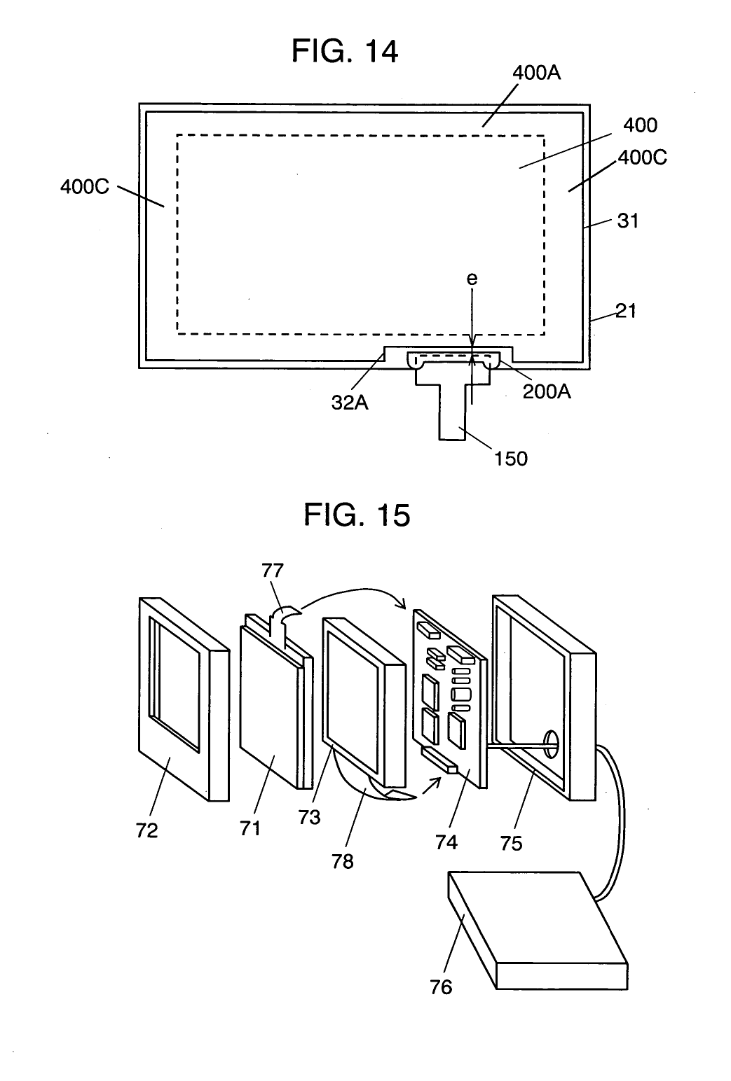

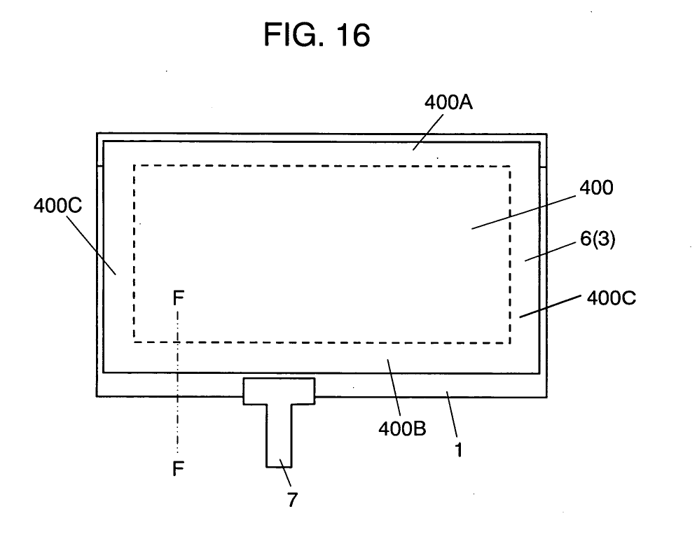

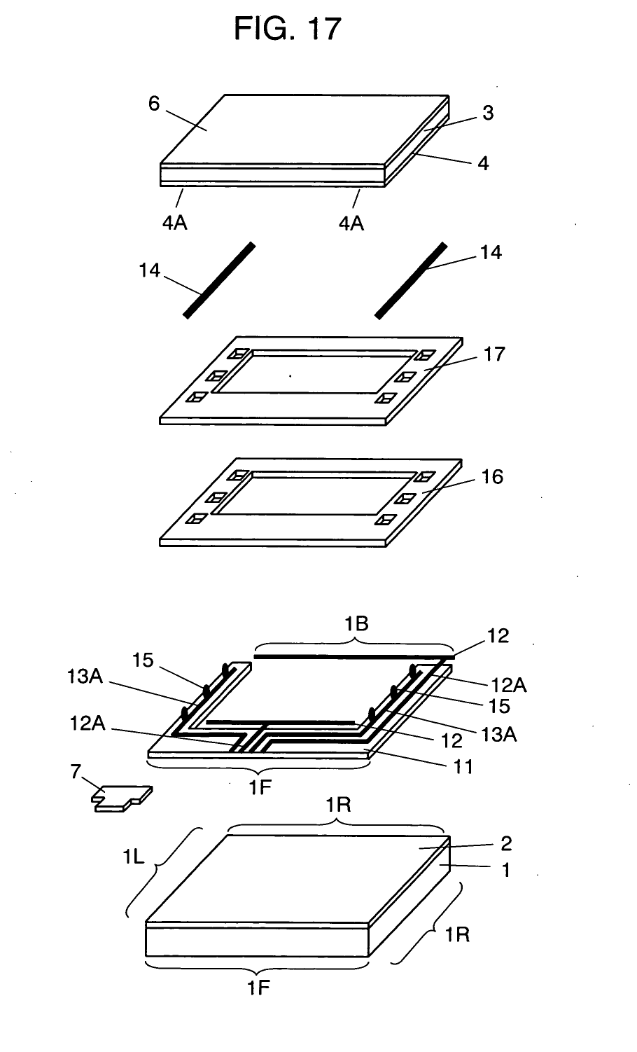

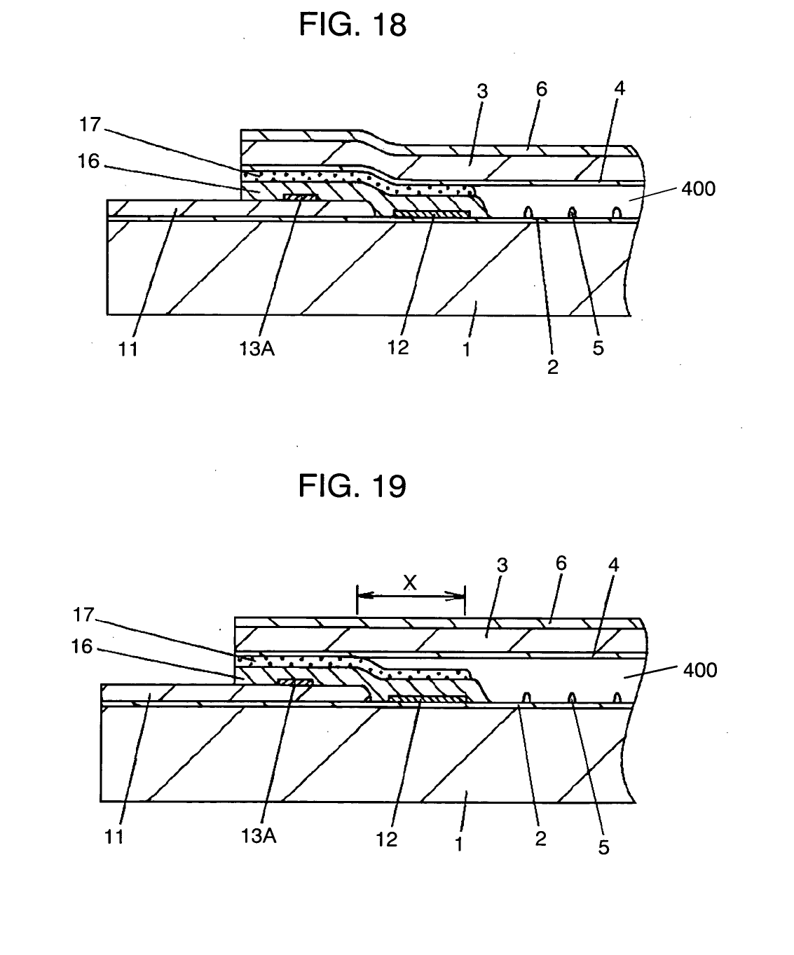

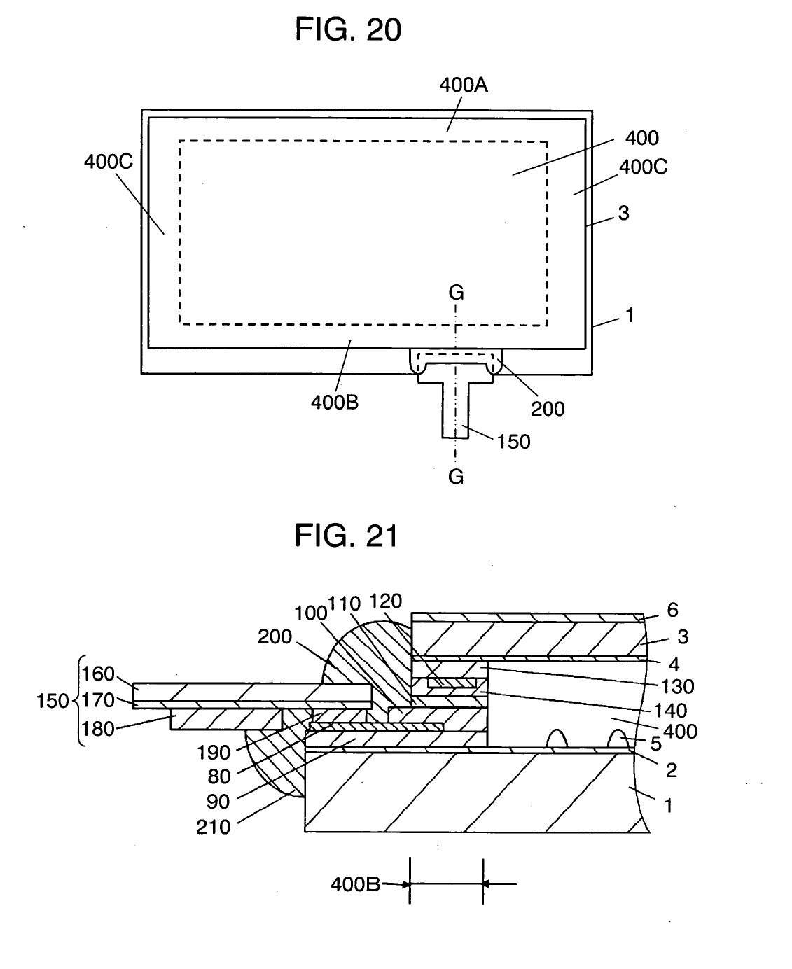

FIG. 14 is a top view of touch panel in a sixth exemplary embodiment of the invention. Same parts as in the fifth exemplary embodiment are identified with same reference numerals, and their explanation is omitted.

The touch panel in the sixth exemplary embodiment has, as shown in FIG. 14, notch 32A at a position corresponding to the vicinity of compression area of FPC 150 of second transparent substrate 31 made of polyethylene terephthalate. The distance e from end of notch 32A and FPC 150 is at least 2 mm or more. The material of protective layer 200A conforms to JIS K 7117-2, that is, silicone resin with viscosity of 3.0 Pa.s is applied and cured, and these points are different from the fifth exemplary embodiment.

The other structure is same as in the fifth exemplary embodiment and explanation is omitted. The touch panel of the sixth exemplary embodiment, same as in the fifth exemplary embodiment, samples were fabricated in sizes of 2 to 15 inches, and presented for environmental tests. The environmental conditions were almost same as in the preceding exemplary embodiments. That is, the environmental test was conducted in the high temperature and high humidity condition of 85° C. and 85% RH for more than 2,000 hours. As a result of the environmental test, the surface smoothness of second transparent substrate 31 was almost unchanged from the initial state. No deterioration was noted in the resistance value between electrode terminals of touch panel, linearity and principal electric characteristics, and the initial characteristics were maintained.

That is, in the structure of the touch panel having the notch as in the sixth exemplary embodiment, the surface smoothness of second transparent substrate 31 was hardly changed in the severe environmental condition of high temperature and high humidity, and the touch panel excellent in visual recognition, controllability and quality, and having high environmental resistance and durability could be obtained.

Besides, since the distance e from end of notch 32A of second transparent substrate 31 corresponding to the position near the compression area of FPC 150 and FPC 150 is at least 2 mm or more, and cold setting silicone resin with viscosity of 3.0 Pa.s is applied to form protective layer 200A, and spread of wetting is suppressed when applying the silicone resin, and it is easier to form protective layer 200A by dispenser, and it is possible to produce at high yield while avoiding contact of protective layer 200A and second transparent substrate 31.

At the side of forming notch 32A in second transparent substrate 31, a wide area of adhesive layer can be kept except for the vicinity of FPC 150 of notch 32A, and visual recognition, controllability and quality are excellent in spite of narrow margin.

In this example, cold setting silicone resin with viscosity of 3.0 Pa.s is used. But as far as the viscosity is 0.7 Pa.s or more, spread of wetting is found to be suppressed when applying the silicone resin, and it is applicable. Considering the application properties, in particular, 1.5 Pa.s or more is found to enhance the productivity of touch panel of the invention, including the structure of the fifth exemplary embodiment. The upper limit of viscosity of protective layer 200A is preferred to be about 30 Pa.s. If the viscosity exceeds 30 Pa.s, sufficient wettability cannot be assured.

### Seventh Exemplary Embodiment

FIG. 15 shows a perspective exploded view of car navigation liquid crystal monitor as an electronic device of a seventh exemplary embodiment of the invention. Touch panel 71 of 7 inches is disposed at the downside of upper case 72. Touch panel 71 may be formed in the same shape and size as in, for example, the touch panel of the first exemplary embodiment (see FIG. 1 to FIG. 3).

It may be also formed in the same shape as the touch panel of the fifth exemplary embodiment. Besides, touch panels used in other exemplary embodiments may be used. Or, as shows in the latter half of the fifth exemplary embodiment, the touch panel may have both insulating layer 27 shown in FIG. 3 and protective layer 200A shown in FIG. 13.

Liquid crystal display device 73 of 7-inch type is disposed beneath touch panel 71 having such structure. Monitor control circuit 74 is disposed beneath liquid crystal display device 73, and is composed of electronic components including central processing unit and memory device not shown in the drawing.

These members and components are arranged in a specific configuration in a space formed by upper case 72 and lower case 75. FPC 77, 78 drawn out from sides of touch panel 71 and liquid crystal display device 73 are connected to connectors disposed in monitor control circuit 74. Car navigation control system main body 76 is connected to monitor control circuit 74. Thus, the electronic device in the seventh exemplary embodiment is specifically applied in a car navigation system.

In actual use of the electronic device of the invention, while operation functions are displayed in liquid crystal display device 73, a position on touch panel 71 corresponding to desired function display position is pressed by finger or pen. Accordingly, on the basis of coordinates position signal from touch panel 71, monitor control circuit 74 controls as specified. For example, the monitor is turned on or off, the software is selected, and the function of the selected software is executed.

The car navigation system was tested in severe environments same as in the preceding exemplary embodiments. Conditions are same as in the preceding environmental tests. That is, the high temperature and high humidity test of 60° C. and 95% RH was conducted for 1,000 hours, and in the heat cycle test, a cycle of −40° C. for 30 minutes and 85° C. for 30 minutes was repeated 1,000 times. After these tests, the function of the touch panel was evaluated. As a result, no abnormality was noted in the operation of touch panel 71, and favorable controllability and excellent reliability of car navigation system were unchanged.

In large liquid crystal panels exceeding 7 inches, touch panel 71 of the invention was similarly applied and evaluated by environmental tests. In this case, too, similar results were obtained, and the operation and function excellent in environmental resistance were confirmed.

The touch panel of the invention is very small in change of surface smoothness of second transparent substrate at touch panel operation side even in severe environment of use of high temperature and high humidity, and the touch panel excellent in visual recognition, controllability and quality can be presented. It is hence useful in application of touch panel mounting devices used in severe environments including car-mount use.

The touch panel of the invention is a touch panel characterized by including an insulating layer for correction of step difference of film thickness in marginal outer circumferential parts for adhering and fixing a first transparent substrate and a second transparent substrate face to face, and adhering the substrates by means of an adhesive layer disposed at a position of uniform height corrected of step difference by the insulating layer. As a result, the adhesion and fixing state is stabilized, and the adhesion strength is enhanced. Hence, in spite of the touch panel of narrow margin reduced in the width of the marginal outer circumferential parts corresponding to the adhesion section, the surface smoothness and environmental resistance are excellent, and it is applicable to severe environments such as car-mount applications.

The touch panel of the invention is installed at the display screen side of liquid crystal display device or the like, and is useful in various electronic devices having input operation unit for input of coordinates positions by pressing operation by pen or finger corresponding to the display item or display content.

The electronic device of the invention can be used sufficiently in severe environments such as atmosphere of high temperature and high humidity, and is excellent in visual recognition, controllability and quality, and electronic devices excellent in durability withstanding severe environments of use such as car-mount applications can be presented, and outstanding industrial merits are brought about.

1. A touch panel comprising a first transparent substrate forming a first transparent conductive film on the upside, a second transparent substrate forming a second transparent conductive film on the downside, and marginal outer circumferential parts for adhering the transparent substrates mutually while keeping the conductive films face to face across a specified interval, wherein a correction insulating layer for correcting step difference in the marginal outer circumferential parts is interposed in the marginal outer circumferential parts, an adhesive layer is formed at the position correcting the step difference by the insulating layer, and the first transparent substrate and second transparent substrate are adhered by the adhesive layer.

2. The touch panel of claim 1, wherein a connector for connection with external device is connected to either one of the first transparent substrate and second transparent substrate, and the other substrate not having the connector has a notch for releasing the outer shape of the connector, and at the notch side and its opposite side, electrodes of transparent conductive films of the substrates are disposed.

3. The touch panel of claim 1, wherein a connector for connection with external device is connected to either one of the first transparent substrate and second transparent substrate, and an electric connection conductor to be electrically connected to the electrode of the transparent conductive film of other substrate is disposed only at the connector connected side.

4. The touch panel of claim 1, wherein a connector for connection with external device is enclosed between the first transparent substrate and second transparent substrate.

5. The touch panel of claim 1, wherein a connector for connection with external device is of double sided substrate type, and is enclosed between the first transparent substrate and second transparent substrate, and wiring patterns drawn out from the electrodes of transparent conductive films of the substrate are electrically connected respectively to the wiring parts disposed at both sides of the connector.

6. The touch panel of claim 1, wherein a polarizer or circular polarizer is disposed on the second transparent substrate.

7. A touch panel comprising a first transparent substrate forming a first transparent conductive film on the upside, a second transparent substrate forming a second transparent conductive film on the downside, a connector connected to at least one of the first transparent substrate and second transparent substrate, and a protective layer applied on the connection area of the connector, wherein the protective layer is not in contact with the transparent substrate not adhered to the connector out of the first transparent substrate and second transparent substrate.

8. The touch panel of claim 7, wherein an insulating layer for correcting step difference is interposed in marginal outer circumferential parts, in marginal outer circumferential parts for adhering the first transparent substrate and second transparent substrate, an adhesive layer is formed at the position corrected of step difference by the insulating layer, and the first transparent substrate and second transparent substrate are adhered by means of the adhesive layer.

9. The touch panel of claim 7, wherein the transparent substrate not adhered to the connector of the first transparent substrate and second transparent substrate has a notch so as not to contact with the protective layer applied around the compression area of the connector.

10. The touch panel of claim 7, wherein the distance between the connector and the transparent substance not adhered to the connector of the first transparent substrate and second transparent substrate is set at 2 mm or more.

11. The touch panel of claim 7, wherein the projective layer around the adhesion area of the connector is made of material of JIS K 7117-2, and formed of a coating agent of cold setting or thermosetting resin with viscosity of 0.7 Pa.s or more.

12. An electronic device having a touch panel of claim 1, disposed at the display screen side of a display device, wherein a specified signal obtained by operation of this touch panel is judged in a control circuit.

13. An electronic device having a touch panel of claim 7, disposed at the display screen side of a display device, wherein a specified signal obtained by operation of this touch panel is judged in a control circuit.
